(19) United States
(12) Patent Application Publication
(10) Pub. No.: US 2025/0049224 A1
(43) Pub. Date: Feb. 13, 2025

(54) METHOD AND APPARATUS FOR ASSEMBLED SHEET AND INFLATABLE PRODUCT, AND MANUFACTURING APPARATUS THEREFOR

(71) Applicant: BESTWAY INFLATABLES & MATERIAL CORP., Shanghai (CN)

(72) Inventor: Xianglin ZENG, Shanghai (CN)

(21) Appl. No.: 18/651,358

(22) Filed: Apr. 30, 2024

(30) Foreign Application Priority Data
Aug. 8, 2023 (CN) 202310996877.X
Aug. 8, 2023 (CN) 202322124932.4

(51) Int. Cl. A47C 27/08; A47G 9/00; A47G 9/06; B32B 3/18; B32B 3/26; B32B 3/30; B32B 5/02; B32B 5/18; B32B 5/24; B32B 7/022; B32B 7/12; B32B 27/08; B32B 27/12

(52) U.S. Cl. CPC A47C 27/081; A47C 27/088; A47G 9/062; B32B 3/18; B32B 3/266; B32B 3/30; B32B 5/02; B32B 5/18; B32B 5/245; B32B 7/022; B32B 7/12; B32B 27/08; B32B 27/12; A47G 2009/003; B32B 2255/10; B32B 2255/205; B32B 2307/304; B32B 2307/536; B32B 2307/7376; B32B 2479/00

(57) ABSTRACT

A sheet, an inflatable product including the sheet, a sheet manufacturing apparatus, and a sheet manufacturing method are provided. The sheet includes layers of first and second polymer materials, the first polymer material having a higher melting point than the second polymer material, and a fabric layer laminated to the first polymer material by adhesive. The apparatus includes feeding devices outputting the first and second polymer materials in a flowable state; a sheet extrusion die converging the first and second polymer materials into a formed material sheet including a barrier layer and a welding layer formed from the first and second polymer materials; and a lamination device using an adhesive to laminate a fabric sheet to the barrier layer of the formed material sheet, and outputting a laminated material sheet including a fabric layer, an adhesive layer, and a substrate layer including the formed material sheet.

### CROSS-REFERENCE TO RELATED APPLICATION

This application claims priority from Chinese Applications CN202310996877.X and CN202322124932.4, both filed Aug. 8, 2023 in China, the disclosures of which are incorporated herein by reference in their entireties.

### BACKGROUND

### 1. Field

Example embodiments relate to the field of sheet manufacturing, and in particular to a sheet, an inflatable product at least partially made of the sheet, a sheet manufacturing apparatus, and a sheet manufacturing method for an inflatable product.

### 2. Description of Related Art

During outdoor camping, campers often require a portable inflatable pad for thermal insulation and cushioning due to the cold and hard ground in the wild. The inflatable pad typically includes a top sheet and a bottom sheet connected to each other to form an inflatable chamber. The top sheet and bottom sheet of existing inflatable pads are usually composite sheets. For example, the top sheet and the bottom sheet may be composite sheets formed by laminating fabric to a thermoplastic polyurethane (TPU) film, where the fabric serves as an outer layer, and the TPU film serves as an inner layer. The role of TPU film is to form an airtight chamber in the inflatable pad. The fabric is breathable, while the TPU film retains the gas inside the product during inflation and prevents air leakage. The fabric is intended to enhance the tactile sensation of the surface of the inflatable pad when a human body comes into contact with the inflatable pad and to improve the comfort of the human body when in contact with inflatable pad.

In order to facilitate the storage and portability of inflatable pads and other related products, it is often desired to make the inflatable pads lightweight and thin. Therefore, while ensuring the airtightness of the inflatable pads, it may be desirable for the thickness of the TPU film to be as thin as possible. Currently, the TPU film used in the composite sheet of most inflatable pads is typically composed of one or more layers of TPU material with uniform melting points, commonly referred to as a single-temperature TPU film.

During the manufacturing process of the inflatable pads, technicians typically place a top sheet formed by fabric laminated to a single-temperature TPU film and a bottom sheet formed by fabric laminated to a single-temperature TPU film together on a welding apparatus. The top sheet is placed with its fabric facing upward and its single-temperature TPU film facing downward, while the bottom sheet is placed with its single-temperature TPU film facing upward and its fabric facing downward. The top sheet is placed over the bottom sheet. Thus, the single-temperature TPU film of the top sheet and the single-temperature TPU film of the bottom sheet are placed facing each other. The technicians then use the welding apparatus to weld the single-temperature TPU film of the top sheet and the single-temperature TPU film of the bottom sheet together. The outer fabric of the top sheet and the outer fabric of the bottom sheet face outward and are not welded to other materials.

When the composite sheet containing the single-temperature TPU film and the fabric is used to make inflatable pad products, high precision is required for the production equipment/die and production process of inflatable pads. Specifically, when the single-temperature TPU film of the top sheet and the single-temperature TPU film of the bottom sheet are welded to each other, there is heat loss during the heat transfer within the welding apparatus, and the heat loss usually fluctuates and is difficult to measure accurately. As a result, the actual welding temperature often deviates from the desired welding temperature, and the deviation itself also fluctuates, making it challenging to control and predict the deviation. In another aspect, dies may be used when welding the single-temperature TPU film of the top sheet and the single-temperature TPU film of the bottom sheet, in which case the technicians typically install the dies above and below the welding apparatus, and the heat of the welding apparatus is transferred to the dies, which in turn transfer the heat to the single-temperature TPU films, thus welding the single-temperature TPU films of the top sheet and the bottom sheet. The shapes, materials, sizes and thicknesses of various dies are different, so the thermal conductivity of each die may be different, which will further lead to the actual welding temperature deviating from the desired welding temperature. In addition, the ambient temperature around the welding apparatus may vary due to different room temperatures during each production, which may also cause the actual welding temperature to deviate from the desired welding temperature. Finally, the welding duration controlled by technicians may also have deviations. Excessive welding time can cause overheating, while insufficient welding time can lead to under heating.

Higher welding temperature or longer welding time may cause over-melting of the single-temperature TPU film, resulting in the formation of small holes or void areas that can lead to gas leakage when the single-temperature TPU film is used in the fabrication of an inflatable pad. Conversely, using a lower welding temperature or shorter welding time may result in insufficient melting of the single-temperature TPU film of the top and bottom sheets of the inflatable pad. This can lead to inadequate adhesion or poor bonding between the top and bottom sheets, preventing the formation of a fully sealed gas chamber and causing gas leakage during the use of the inflatable pad, rendering the inflatable pad unusable.

To sum up, when using composite sheets formed by laminating a single-temperature TPU film and fabric to manufacture inflatable pads, it is challenging to achieve precise control over welding temperature and welding time due to inherent limitations in equipment, environment, and manual operation. Whether using higher welding temperature and/or longer welding time or lower welding temperature and/or shorter welding time, it can ultimately result in gas leakage of the inflatable pads, leading to product defects and a decrease in the quality of the final products.

### SUMMARY

Example embodiments may address at least the above problems and/or disadvantages and other disadvantages not described above. Also, example embodiments are not required to overcome the disadvantages described above, and may not overcome any of the problems described above.

The following summary of the invention is exemplary and explanatory only and is not necessarily restrictive of the invention as claimed. The summary is intended to present general aspects of the present invention in order to provide a basic understanding of at least some features of the invention. This summary is not an extensive overview of the invention. It is not intended to identify key or critical elements of the invention or to delineate the scope of the invention. The following summary merely presents some concepts of the invention in a general form as a prelude to the more detailed description provided below. Example embodiments may address at least the above problems and/or disadvantages and other disadvantages not described above. Also, example embodiments are not required to overcome the disadvantages described above, and may not overcome any of the problems described above.

Further, it should be noted that in various embodiments, description is made with reference to figures, in which like reference numerals refer to similar or identical items in the drawings, unless otherwise indicated herein. However, certain embodiments may be practiced without one or more of these specifically identified details, or in combination with other known methods and configurations. In the following summary and detailed description, numerous details are set forth, such as specific configurations, dimensions and processes, etc., in order to provide a thorough understanding of the present invention. In other instances, well-known processes and conventional hardware have not been described in particular detail in order to not unnecessarily obscure the present invention. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “an embodiment,” or the like in various places throughout this specification are not necessarily referring to the same embodiment of the invention. Furthermore, the particular features, structures, configurations, or characteristics may be combined in any suitable manner in one or more embodiments.

Additionally, the terms “top sheet” and “bottom sheet” as utilized herein may interchangeably refer, respectively, to a “first sheet” and a “second sheet.” As such, non-limiting embodiments utilized herein do not necessarily require the “top sheet” or “first sheet” to be disposed above or on top of the “second sheet” or “bottom sheet,” provided such sheets are disposed to connect to one another to form an inflatable chamber.

According to an aspect of an example embodiment, a sheet comprises: a substrate layer including: a barrier layer comprising a first polymer material; and a welding layer comprising a second polymer material; wherein: a melting point of the first polymer material is higher than a melting point of the second polymer material.

The substrate layer may be formed by converging the first polymer material in a flowable state and the second polymer material in a flowable state.

The substrate layer may further comprise an intermediate layer disposed between the barrier layer and the welding layer, wherein the intermediate layer comprises a mixture of the first polymer material and the second polymer material. In a further aspect, the substrate layer has a thickness in a range of about 0.01 millimeters (mm) to 0.40 mm.

Each of the first polymer material and the second polymer material comprises at least one of a thermoplastic polyurethane elastomer, polyethylene, polypropylene, polyvinyl chloride, polyvinylidene chloride, polyurethane, and a thermoplastic polyurethane elastomer.

The melting point of the first polymer material may be at least 15° C. higher than the melting point of the second polymer material.

The barrier layer may have a Shore A hardness (HA) in a range of about 80 HA to 98 HA, and the welding layer may have a Shore A hardness in a range of about 75 HA to 95 HA. Additionally, a ratio of a thickness of the barrier layer to a thickness of the welding layer may be in a range of about 1:1 to 1:4.

A sheet may further comprise a fabric layer and an adhesive layer disposed between the fabric layer and the barrier layer, the adhesive layer joining the fabric layer to the barrier layer to form a laminated sheet. The adhesive layer may comprise any desired adhesive, and in one embodiment, the adhesive layer comprises a polyurethane adhesive. In additional embodiments, the polyurethane adhesive comprises one of a solvent-based polyurethane adhesive, a water-based polyurethane adhesive, and a polyurethane reactive hot melt adhesive. In yet another embodiment, the fabric layer comprises a fabric material and a polyurethane coating on a side of the fabric material facing the adhesive layer.

An inflatable product may comprise any aspects of the sheet as set forth above. Further, according to an aspect of another embodiment, an inflatable product may comprise a first (or “top”) sheet; and a second (or “bottom”) sheet connected to the first (or “top”) sheet, such that the first (or “top”) sheet and the second (or “bottom”) sheet jointly define an inflatable chamber therebetween; wherein at least one of the first (or “top”) sheet and the second (or “bottom”) sheet comprises a layered sheet comprising: a fabric layer; an adhesive layer; and a substrate layer including a barrier layer comprising a first polymer material and a welding layer comprising a second polymer material, wherein a melting point of the first polymer material is higher than a melting point of the second polymer material, wherein the fabric layer is joined to the adhesive layer to laminate the fabric layer to the barrier layer.

The inflatable product may further comprise a connecting sheet disposed in the inflatable chamber between the first (or “top”) sheet and the second (or “bottom”) sheet; wherein the connecting sheet comprises: a plurality of first welding regions in which the connecting sheet is welded to the first (or “top”) sheet, and a plurality of second welding regions in which the connecting sheet is welded to the second (or “bottom”) sheet, wherein the plurality of first welding regions are staggered with respect to the plurality of second welding regions.

The inflatable product may additionally comprise: a thermal insulation sheet disposed in the inflatable chamber; wherein the thermal insulation sheet comprises: a polymer substrate, and a metal coating layer coated on at least one side of the polymer substrate. In various aspects, the polymer substrate of the thermal insulation sheet may be formed from at least one of polyvinyl chloride, polypropylene, and polyethylene terephthalate, and in additional embodiments, the metal coating layer of the thermal insulation sheet may be formed from at least one of aluminum, zinc, copper, silver, or gold.

The inflatable product may further comprise: a plurality of tensioning members disposed in the inflatable chamber; wherein each of the plurality of tensioning members comprises a top edge welded to the welding layer of the first (or “top”) sheet and a bottom edge welded to the welding layer of the second (or “bottom”) sheet. Additionally, each of the plurality of tensioning members may comprise a substrate layer comprising a first tensioning layer comprising a first polymer material and a second tensioning layer comprising a second polymer material, wherein a melting point of the first polymer material is higher than a melting point of the second polymer material. In further embodiments, each of the plurality of tensioning members may comprise polyamide fiber or polyethylene terephthalate fiber. In yet another aspect, each of the plurality of tensioning members may further comprise a tensioning fabric layer and a tensioning adhesive layer, wherein the tensioning fabric layer is joined to the tensioning adhesive layer to laminate the tensioning fabric layer to the first tensioning layer.

The inflatable product may further comprise a foam core disposed in the inflatable chamber; wherein a top surface of the foam core is laminated to the first (or “top”) sheet and a bottom surface of the foam core is laminated to the second (or “bottom”) sheet. The foam core may also comprise one of a plurality of uniformly-distributed apertures and a plurality of uniformly-distributed grooves. Further, the inflatable product may further include an inflation valve, wherein: the foam core disposed within the inflatable product may be compacted to assume a smaller volume thereof by application of an external compressive force and expands upon removal of the external compressive force; the inflatable product may be configured into a decreased volume storage configuration by: translating the inflation valve to an open position thereof; applying the external compression force to an external area of the inflatable product, thereby compressing the foam core and expelling gasses from within the inflatable product; and translating the inflation valve to a closed position thereof, thereby preventing external gasses from re-entering the inflatable product and retaining the foam core in a compressed state thereof by external air pressure acting on external surfaces of the inflatable product; and the inflatable product may be configured into an inflated use configuration by: translating the inflation valve to an open position thereof, whereby an expansive force of the compressed foam core urges external gasses to enter the inflatable product; and translating the inflation valve to a closed position thereof after the inflatable product has expanded to a predetermined volume to maintain the inflatable product in the inflated use configuration.

In an additional embodiment, the inflatable product may further comprise: a lateral sheet; wherein a top edge of the lateral sheet is connected to a periphery of the first (or “top”) sheet, and a bottom edge of the lateral sheet is connected to a periphery of the second (or “bottom”) sheet, such that the first (or “top”) sheet, the second (or “bottom”) sheet, and the lateral sheet jointly define the inflatable chamber. In yet another aspect, the first (or “top”) sheet of the inflatable product may be directly welded to the second (or “bottom”) sheet at a plurality of distributed weld lines and weld points so that the inflatable pad maintains a predetermined shape in an inflated state.

There is also provided a sheet manufacturing apparatus comprising: a first feed hopper configured to output a first polymer material in a flowable state; a second feed hopper configured to output a second polymer material in a flowable state, wherein a melting point of the first polymer material is higher than a melting point of the second polymer material; a sheet extrusion die comprising a first flow channel, a second flow channel, a converging chamber, and a die outlet, wherein: the first flow channel is configured to direct the first polymer material from the first feed hopper into the converging chamber, the second flow channel is configured to direct the second polymer material from the second feed hopper into the converging chamber, the converging chamber is configured to direct the first polymer material and the second polymer material together into the die outlet, and the die outlet is configured to output a formed material sheet comprising a barrier layer comprising the first polymer material and a welding layer comprising the second polymer material; a third feeding device configured to output a fabric sheet; a lamination device configured to use an adhesive material to laminate the fabric sheet to the barrier layer of the formed material sheet, and thereby output a laminated material sheet comprising a fabric layer comprising the fabric sheet, an adhesive layer comprising an adhesive material, and a substrate layer comprising the formed material sheet.

In one aspect, the lamination of the sheet manufacturing apparatus device may be configured to: apply the adhesive material onto one or more of the fabric sheet and the barrier layer of the formed material sheet; and laminate the fabric sheet to the formed material sheet through adhesion provided by the adhesive material on the one of the fabric sheet and the barrier layer of the formed material sheet. In an additional embodiment, the sheet manufacturing apparatus may further include a pressing device configured to receive the formed material sheet from the sheet extrusion die and to press the formed material sheet by at least one of flattening and embossing to create a pressed material sheet.

The sheet manufacturing apparatus may further comprise: a cooling device configured to receive the pressed material sheet from the pressing device and to cool the pressed material sheet to create a cooled material sheet, and in an additional embodiment, the sheet manufacturing apparatus may also include a trimming device configured to receive the cooled material sheet from the cooling device, and to trim the cooled material sheet to create a trimmed material sheet.

The sheet manufacturing apparatus may further comprise a winding device configured to receive the trimmed material sheet from the trimming device and to wind the trimmed material sheet into a first roll; and an unwinding device configured to receive and unwind the first roll. In yet another embodiment, the sheet manufacturing apparatus may also include a trimming device configured to receive the laminated material sheet from the lamination device and to trim the laminated material sheet. Further, the sheet manufacturing apparatus may further comprise a pressing device configured to receive the laminated material sheet from the lamination device and to press the laminated material sheet by at least one of flattening and embossing. In various embodiments, the lamination device may be configured to press the laminated material sheet by at least one of flattening and embossing.

The sheet manufacturing apparatus may also comprise a cooling device configured to receive the laminated material sheet from the lamination device and to cool the laminated material sheet to create a cooled material sheet, and may additionally include a trimming device configured to trim the cooled material sheet.

In yet a further exemplary embodiment, there is presented a sheet manufacturing method comprising: providing a first polymer material in a flowable state, a second polymer material in a flowable state, and a fabric sheet, wherein a melting point of the first polymer material is higher than a melting point of the second polymer material; forming a formed material sheet comprising a barrier layer comprising the first polymer material and a welding layer comprising the second polymer material; laminating the fabric sheet to the barrier layer of the formed material sheet using an adhesive material, thereby forming a laminated material sheet including: a fabric layer comprising the fabric sheet; an adhesive layer comprising the adhesive material; and a substrate layer comprising the formed material sheet.

In an additional aspect, the formed material sheet may further comprise an intermediate layer disposed between the barrier layer and the welding layer, wherein the intermediate layer comprises a mixture of the first polymer material and the second polymer material. Additionally, each of the first polymer material and the second polymer material is a thermoplastic polyurethane elastomer.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a schematic perspective view of a first example embodiment of an inflatable pad;

FIG. 2 is a schematic exploded view of the inflatable pad of FIG. 1;

FIG. 3A is a schematic cross-sectional view of an inflatable pad;

FIG. 3B is a schematic diagram of a thermal insulation sheet of an inflatable pad;

FIG. 4 is a schematic exploded view of a second example embodiment of an inflatable pad;

FIG. 5 is a schematic exploded view of a third example embodiment of an inflatable pad;

FIG. 6 is a schematic exploded view of a fourth example embodiment of an inflatable pad;

FIG. 7 is a schematic exploded view of a fifth example embodiment of an inflatable pad;

FIG. 8 is a schematic exploded view of a sixth example embodiment of an inflatable pad;

FIG. 9 is a schematic exploded view of a seventh example embodiment of an inflatable pad;

FIG. 10 is a schematic perspective view of an eighth example embodiment of an inflatable;

FIG. 11 is a schematic exploded view of the inflatable pad of FIG. 10;

FIG. 12 is a schematic diagram of an example embodiment of a sheet;

FIG. 13 illustrates a block diagram of a sheet manufacturing apparatus of the present invention;

FIG. 13A illustrates a schematic diagram of a sheet former assembly of the sheet manufacturing apparatus of FIG. 13.

FIG. 13B illustrates a schematic diagram of a fabric laminator assembly of the sheet manufacturing apparatus of FIG. 13.

FIG. 14A is an enlarged partial cross-sectional schematic view of the first portion of the sheet manufacturing apparatus of FIG. 13A;

FIG. 14B is another enlarged partial cross-sectional schematic view of the first portion of the sheet manufacturing apparatus of FIG. 13A;

FIG. 15 is a schematic diagram of the second portion of a second example embodiment of a sheet manufacturing apparatus;

FIG. 16 is a schematic diagram of a third example embodiment of a sheet manufacturing apparatus;

FIG. 17 is a schematic diagram of a fourth example embodiment of a sheet manufacturing apparatus;

FIG. 18 is a schematic diagram of a fifth example embodiment of a sheet manufacturing apparatus; and

FIG. 19 is a schematic flow chart of an example embodiment of a sheet manufacturing method.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. The terms “first”, “second”, etc. should not be construed as indicating or implying relative importance or implying the number of technical features indicated. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

In this description, the expression of structural positions of components, such as upper, lower, top, and bottom, are not absolute but relative. The orientation expressions are appropriate when the various components are arranged as shown in the figures, but should change accordingly when the positions of the components in the figures change. In the present invention, the terms such as “mount,” “engage,” “connect,” and “fix” should be interpreted in a broad sense unless explicitly defined otherwise, which, for example, may refer to a fixed connection, a detachable connection, or an integral connection; or may refer to a direct connection, or an indirect connection by means of an intermediate medium. For those of ordinary skill in the art, the specific meaning of the terms mentioned above in the present invention should be construed according to specific circumstances.

Herein, an “inflatable product” has at least one inflatable chamber for inflating. When the pressure of a gas (e.g. air) in the inflatable chamber reaches a desired value, the inflatable product is in an inflated state and may maintain a certain shape. Once the gas in the inflatable chamber of the inflatable product is discharged, the inflatable product is in a deflated state, and the volume of the inflatable product is reduced compared to when it is inflated, thus facilitating the storage of the inflatable product. The inflatable product includes but is not limited to an inflatable pad, an inflatable pool, an inflatable toy, an inflatable sofa, an inflatable tent, and any of various other products.

Additionally, as mentioned above the terms “top sheet” and “bottom sheet” as utilized herein may interchangeably refer, respectively, to a “first sheet” and a “second sheet.” As such, embodiments described herein do not necessarily require the “top sheet” or “first sheet” to be disposed above or on top of the “second sheet” or “bottom sheet,” provided such sheets are disposed to connect to one another to form an inflatable chamber.

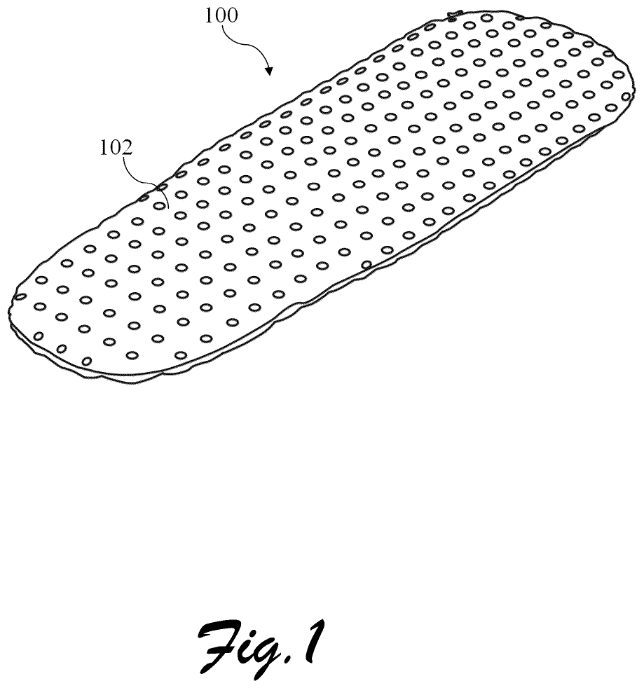

FIGS. 1 to 11 illustrate various example embodiments of an inflatable pad.

Referring to FIG. 1, a schematic perspective view of a first example embodiment of an inflatable pad 100 with a top sheet 102 is shown. The surface of the top sheet 102 may be provided with a pattern which may be regular. Possible example embodiments thereof are explained hereafter.

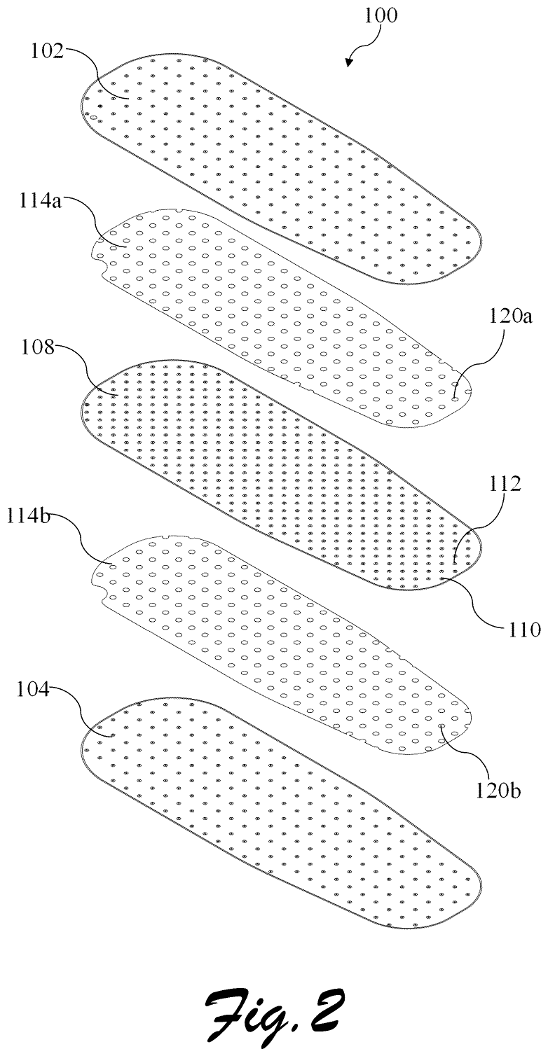

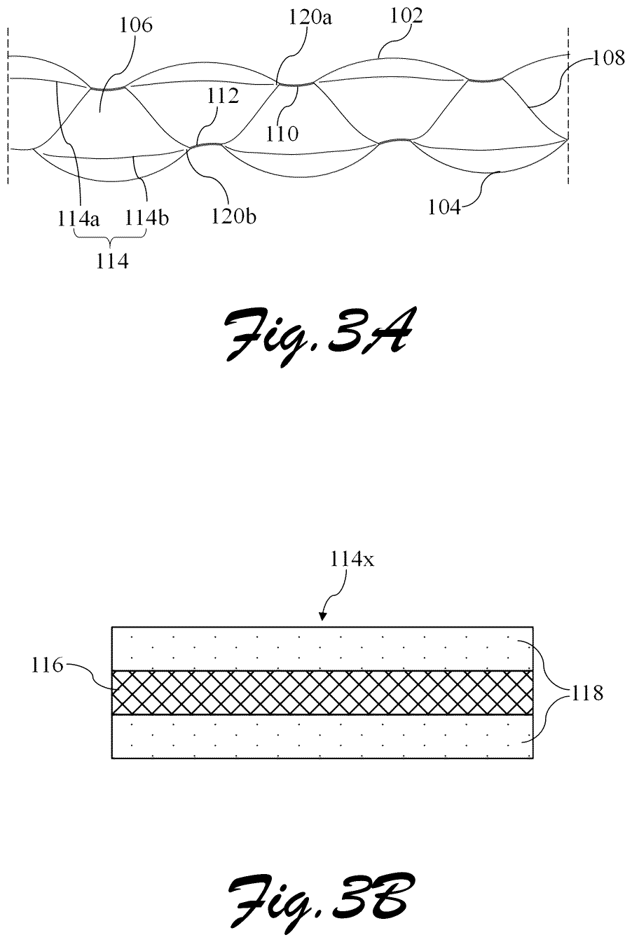

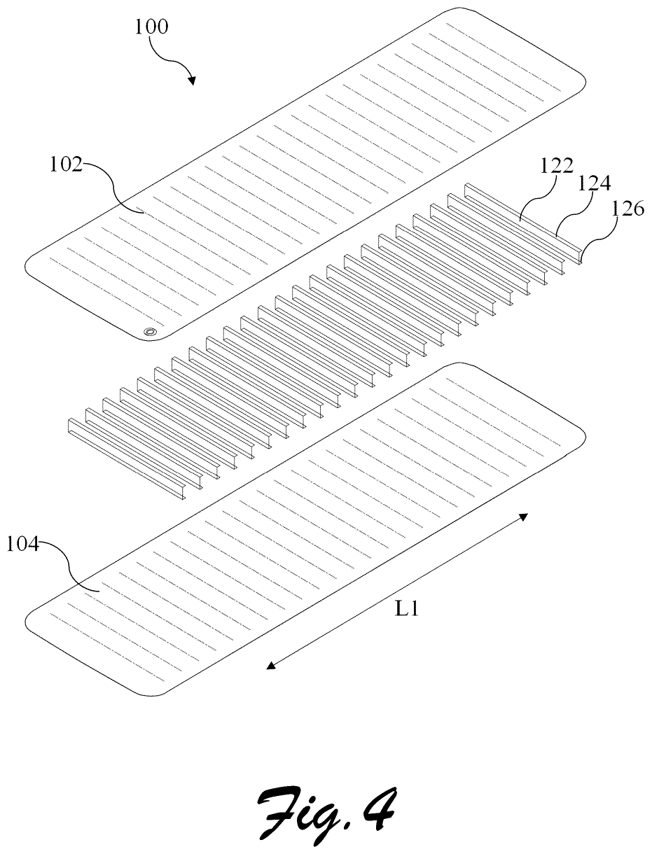

Referring to FIG. 2, a schematic exploded view of the inflatable pad of FIG. 1 is shown, wherein the inflatable pad 100 includes a top sheet 102 and a bottom sheet 104. The top sheet 102 and the bottom sheet 104 are connected to each other to jointly define an inflatable chamber 106 (see e.g., FIG. 3A). The top sheet 102 may be configured for the user to sit or lie on, and the bottom sheet 104 may be configured to be in contact with the ground. The top sheet 102 and the bottom sheet 104 may have substantially the same shape and size, and the outer periphery of the top sheet 102 and the outer periphery of the bottom sheet 104 are welded to each other by, for example, high frequency welding, hot press welding, ultrasonic welding, or any of a variety of other attachment approaches as would be understood to enable defining of the inflatable chamber 106 between the top sheet 102 and the bottom sheet 104.

FIG. 3A is a schematic cross-sectional view of an inflatable pad 100 which may be used for the inflatable pad of FIG. 1 and FIG. 2. The structure of the inflatable pad 100 will be further explained below.

FIG. 3B is a schematic diagram of a thermal insulation sheet 114x which may be used for the inflatable pad of FIG. 1 and FIG. 2. The structure of the thermal insulation sheet 114x will be further explained below.

The outer sides of the top sheet 102 and the bottom sheet 104 of the inflatable pad 100, facing away from the inflatable chamber 106, may provide a comfortable feel to the user; the inner sides of the top sheet 102 and the bottom sheet 104, opposite their outer sides, facilitate easier welding during the manufacturing of the inflatable pad 100; and the top sheet 102 and the bottom sheet 104 may retain good mechanical strength and air tightness after being welded in the process of manufacturing the inflatable pad 100, so that the inflatable pad 100 is aided in maintaining a predetermined shape without leaking air while in the inflated state.

To this end, one or more example embodiments described herein may assist with preparing an improved sheet 200. FIG. 12 shows a schematic diagram of an example embodiment of a sheet 200 according to the present invention.

Referring to FIG. 12, a sheet 200 may include: a fabric layer 202, an adhesive layer 204, and a substrate layer 206. The substrate layer 206 includes a barrier layer 208, an intermediate layer 212, and a welding layer 210. The barrier layer 208 includes a first polymer material, and the welding layer 210 includes a second polymer material. The first polymer material has a melting point higher than that of the second polymer material. The substrate layer 206 is formed by converging the first polymer material in a flowable/molten state and the second polymer material in a flowable/molten state. As described in more detail below, the intermediate layer 212 may include a mixture of the first polymer material and the second polymer material to more securely bond the barrier layer 208 and the welding layer 210. The fabric layer 202 may be laminated to the barrier layer 208 through the adhesive layer 204.

Both the top sheet 102 and the bottom sheet 104 of the inflatable pad 100 in FIG. 2 may be manufactured from the sheet 200, or alternately, only one of the two sheets 102, 104 may be manufactured from the sheet 200. For instance, one of the top sheet 102 and the bottom sheet 104 may comprise the substrate layer 206 of the sheet 200 but not the fabric layer 202 or the adhesive layer 204. The sheet 200, according to example embodiments, will be described below mainly by making example reference to a sheet 200 for use in manufacturing inflatable pads. It is to be appreciated that a sheet 200 according to any example embodiment described herein may also be used to manufacture inflatable products other than inflatable pads or to manufacture non-inflatable products.

During the manufacturing of an inflatable pad 100 including a sheet 200 as described, for example, with respect to FIG. 12, the fabric layer 202 may be positioned on the outer side of the top sheet 102, facing away from the inflatable chamber 106, and on an outer side of the bottom sheet 104, facing away from the inflatable chamber 106, to provide a comfortable feel, and to provide slip resistance while the inflatable pad is in use. The welding layer 210 of the substrate layer 206, formed of the second polymer material with a lower melting point, may reside on the inner side of the top sheet 102, facing the inflatable chamber 106, and on the inner side, facing the inflatable chamber 106, of the bottom sheet 104, for welding. The barrier layer 208 of the substrate layer 206 formed of the first polymer material with a higher melting point, may thereby be located between the fabric layer 202 and the welding layer 210 and may form an impermeable barrier within the top sheet 102 and the bottom sheet 104.

When welding the top sheet 102 and the bottom sheet 104, such as welding the top sheet 102 and the bottom sheet 104 to each other or welding the top sheet 102 or the bottom sheet 104 to other components within the inflatable chamber 106 (the other components within the inflatable chamber 106 will be described further below), a welding temperature may be set between the melting point of the first polymer material and the melting point of the second polymer material. Thereby, the welding layer 210 with the lower melting point can be melted for welding, while the barrier layer 208 with the higher melting point remains structurally intact and thus impermeable. Use of this technique may aid in reducing the sensitivity of the product quality to variations in the welding temperature. In other words, even if there is a deviation in the welding temperature, regardless of whether the welding temperature deviation is high or low, as long as the resulting temperature is still between the melting point of the first polymer material and the melting point of the second polymer material, this technique may aid in enabling the manufactured products to remain compliant and meet the required standards or functional requirements. Accordingly, a sheet 200 according to one or more example embodiments described herein may provide a number of benefits. For example, embodiments of such a sheet 200 may contribute to reducing the negative influences of welding temperature variations and welding time deviations on the product quality, thereby also aiding in reducing air leakage issues of the assembled inflatable products, improving the air tightness of the manufactured inflatable products, increasing yield rate, reducing production costs, and reducing human error and improving productivity by simplifying the welding operation for technicians.

Moreover, forming the substrate layer 206, by converging the first polymer material in a flowable state and the second polymer material in a flowable state, assists in reducing or eliminating the formation of bubbles or voids between the barrier layer 208 and the welding layer 210, and further contributes to increasing bonding strength between the barrier layer 208 and the welding layer 210, making these layers less prone to separation or delamination. In particular, the connection between the barrier layer 208 and the welding layer 210 is formed in a materially bonded manner. The substrate layer 206 formed by converging the first and second polymer materials in a flowable state may further include an intermediate layer 212 between the barrier layer 208 and the welding layer 210. The intermediate layer 212 may include a mixture of the first polymer material and the second polymer material to more securely bond the barrier layer 208 and the welding layer 210. Optionally, the substrate layer 206 may be formed by extrusion which will be described in detail below. In the context of example embodiments described herein, the term “flowable state” refers to a state of the first or second polymer material in which the polymer material is partially or completely molten or, in other words, the polymer material is at least in part or completely in an amorphous liquid state. In particular, the polymer material being in a flowable state has a temperature at or above its melting point. According to one or more example embodiments, the temperature of the polymer material in a flowable state exceeds the melting point of the polymer material by about 5 K or more in one instance, or about 10 K or more in another instance. Depending on the kind of polymer material, the temperature of the polymer material in a flowable state is about 5 to 100 K, or about 10 to 40 K, above the melting point of the subject polymer material.

The thickness of the substrate layer 206 including the barrier layer 208 and the welding layer 210 may be approximately the same as that of prior art substrate layers having only one layer of a single-temperature TPU film. Thus, the sheet 200 according to one or more example embodiments may maintain desirable characteristics of being thin and lightweight. Further, compared with a substrate layer of a single-temperature TPU film, a substrate layer 206 including the barrier layer 208 and the welding layer 210 may have lower requirements for a welding operation and may be able to withstand a wider range of welding temperature and time variations without affecting product quality. Thus, the substrate layer 206 of the present invention including the barrier layer 208 and the welding layer 210 can be made thinner than the substrate layer of a single-temperature TPU film, thereby aiding in the creation of lighter-weight inflatable products made of the sheet 200 compared to single-temperature TPU films.

The fabric layer 202 of the sheet 200 comprises fabric material. Optionally, the fabric material may be, but is not limited to, a flat fabric material or a three-dimensional fabric material, or any of various other arrangements of fibers and threads. Optionally, the fabric material may be made of one or more types of fibers (e.g. natural fibers or chemical fibers), in particular one or more types of fibers having high tensile strength. Optionally, the one or more types of fibers may be selected from the following materials: cotton fiber, wool fiber, silk fiber, hemp fiber, regenerated fiber, polyester fiber, polyamide fiber, polyacrylonitrile fiber, polyvinyl alcohol fiber, polypropylene fiber, polyurethane fiber, and inorganic fiber.

Optionally, the adhesive layer 204 of the sheet 200 may be formed of polyurethane adhesive including, but not limited to, solvent-based polyurethane (PU) adhesive, water-based PU adhesive, or PUR hot melt adhesive (also known as moisture-curing polyurethane reactive hot melt adhesive). The solvent-based PU adhesive may provide advantages such as one or more of high initial adhesion, high bonding degree in a short time, and a high peel strength, that is, a high resistance to peel-off of the surface film, among other possible advantages. A water-based PU adhesive utilizes water as a carrier, which may be considered to be more environmentally friendly. A PUR hot melt adhesive may provide advantages such as one or more of being solvent-free, water-resistant, heat-resistant, cold-resistant, and creep-resistant, among other possible advantages. It is to be appreciated that the adhesive layer 204 of the sheet 200 may also be formed of any of a variety of other suitable adhesive materials, or a combination of adhesive materials.

Optionally, the fabric layer 202 may be coated with a polyurethane (PU) coating on a side to be laminated to the adhesive layer 204 to contribute to enhancing a bonding effect of the fabric layer 202 and the adhesive layer 204, thereby enhancing the bonding strength of the fabric layer 202 and the substrate layer 206. Such PU-coated fabric may offer particular advantage in a case in which the fabric material (for example, a fabric material made of polyamide fiber) of the fabric layer 202 itself is directly laminated to the adhesive layer 204 with a low bonding strength. The combined PU-coated fabric layer 202 and the substrate layer 206 together offer enhanced resistance to being torn apart by an external force through the added tensile strength provided by the polyurethane coating on the fabric layer.

Optionally, the first polymer material and the second polymer material used to form the substrate layer 206 are thermoplastic polymer materials. Optionally, the first polymer material and the second polymer material may comprise one or more of: thermoplastic polyurethane elastomer (TPU), polyethylene (PE), polypropylene (PP), polyvinyl chloride (PVC), polyvinylidene chloride (PVDC), and polyurethane (PU). Alternatively, the first polymer material and/or the second polymer material may comprise only one of said materials. The first polymer material and the second polymer material may be the same kind of material or different kinds of materials. For example, when the first polymer material and the second polymer material are of the same kind, the first polymer material and the second polymer material may both be one of thermoplastic polyurethane elastomer, polyethylene, polypropylene, polyvinyl chloride, polyvinylidene chloride, and polyester. In some example embodiments, the first polymer material and the second polymer material may both be thermoplastic polyurethane elastomers. Optionally, the melting point of the first polymer material is at least 15° C. higher than that of the second polymer material to contribute to improved welding strength while preventing air leakage due to damage of the sheet 200 during the welding operation. In another example embodiment, the melting point of the first polymer material is at least 17° C. higher, or at least 20° C. or higher than a melting point of the second polymer material. A melting point difference between the first polymer material and the second polymer material may be smaller than 50° C., or smaller than 30° C. Optionally, according to one non-limiting example, the melting point of the first polymer material is in a range of about 140° C. to 150° C., and the melting point of the second polymer material is in a range of about 120° C. to 130° C.

The term “melting point” as used herein refers to the melting temperature. The melting point is determined using Differential Scanning calorimetry (DSC) according to ISO 11357-3:2018 applying a heating rate of 10 K/min. Relevant definitions and testing methods are found in (International Organization for Standardization) ISO 11357-1. To perform the test, the sample is placed into an instrument, and the instrument heats up at a heating rate of 10 K/min. During the endothermic melting process of the sample, the instrument displays a heating curve. For the polymer material, the melting peaking temperature, denoted as Tp,m in the ISO 11357-3 standard, is used as the “melting point” of the polymer material. Thus, melting point peak temperatures Tp,m of two materials are compared. When a range is given, melting point peak temperature Tp,m of the first and the second polymer material are taken to compare whether a difference of the melting points of the first and second polymer materials is at least 15° C., or at least 17° C., or at least 20° C. For example, the melting point of the first polymer material may be about 150° C., and the melting point of the second polymer material may be about 130° C.

The measurement of the Shore hardness for plastics is conducted according to ISO 868. This standard specifies composition and specifications of the testing instrument. Under defined testing conditions, a specified-shaped durometer is pressed into the test material, and the depth of penetration is measured vertically. The numerical value displayed at this point is the Shore hardness value. In regards to the present invention, optionally, the barrier layer 208 of the substrate layer 206 may have a Shore A hardness in a range of about 80 HA to 98 HA, and the welding layer 210 may have a Shore A hardness in a range of about 75 HA to 95 HA. In other words, the Shore A hardness of the barrier layer 208 may be higher than the Shore A hardness of the welding layer 210, for example by 5 HA, or by 10 HA. The differences in Shore A hardness ranges may be analyzed by comparing both lower bounds, both upper bounds, or both medians of the hardness intervals to each other. Thus, in various embodiments, the sheet 200 achieves a suitable balance between softness and hardness, so as to contribute to limiting an uncomfortable feel of the sheet 200 caused by excessive hardness and increased vulnerability to wrinkling and damage on the exterior surface once formed into an inflatable product. Such hardness differences between the barrier layer 208 and the welding layer 210 also help prevent the assembled sheet 200 from being overly soft, which would complicate the manufacturing process (for example, causing the sheet or the semi-finished product of the sheet in the sheet manufacturing process to be difficult to flatten or manipulate). As additional explanatory ranges of the Shore A hardness metric in view of various embodiments of the present invention, a Shore A hardness higher than 98 may be considered an excessive level of hardness, and a Shore A hardness lower than 75 may be considered overly soft.

In various embodiments, when the sheet 200 is used to manufacture an inflatable pad 100, a thickness of the substrate layer 206 of the sheet 200 may be in a range of about 0.01 mm to 0.4 mm, or in a range of about 0.05 mm to 0.25 mm. Optionally, when the sheet 200 is used to manufacture other inflatable products or non-inflatable products, the thickness of the substrate layer 206 of the sheet 200 may be in a range of about 0.01 mm to 2 mm.

In additional embodiments, a ratio of the thickness of the barrier layer 208 to the thickness of the welding layer 210 of the substrate layer 206 falls within a range of about 1:1 to 1:4. In particular, a ratio of 1:2 or 1:3 may be used. In other words, the thickness of the welding layer 210 may be equal to or larger than the thickness of the barrier layer 208. In one particular embodiment, a thickness of the welding layer 210 is larger than the thickness of the barrier layer 208. In this way, the thickness ratio of the barrier layer 208 to the welding layer 210 of the substrate layer 206 may be measured and determined to achieve desired results. For example, one or more embodiments may contribute to preventing a degradation of the weldability of the sheet 200 due to an excessive ratio of a thickness of the barrier layer 208 to a thickness of the welding layer 210; put another way, in undesired scenarios, the welding layer 210 may be formed too thin compared to the thickness of the barrier layer 208 to achieve reliable welds. For example, an embodiment in which an inflatable pad 100 is made using the sheet 200 may contribute to preventing damage of the inflatable pad 100 due to the insufficient strength of the welding between the top sheet 102 and the bottom sheet 104 made of the sheet 200, and/or the welding between each of the top and bottom sheets 102, 104 and other components in the inflatable chamber 106. One or more example embodiments may also contribute to avoiding an insufficient ratio of a thickness of the welding layer 210 relative to a thickness of the barrier layer 208, and such a selected ratio may aid in preventing welding temperature and time from being poorly controlled resulting in the welding layer 210 completely melting and subsequently affecting the barrier layer 208, leading to its melting and damage. For example, in an example embodiment in which the sheet 200 is used to manufacture inflatable pads 100, the appropriately-selected ratio may contribute to preventing damage and air leaks in the inflatable pads 100, thereby improving the yield rate of the inflatable pads 100. The ratio of the thickness of the barrier layer 208 to the thickness of the welding layer 210 of the substrate layer 206 may be about 1:2. Optionally, in some example embodiments, the barrier layer 208 of the substrate layer 206 has a thickness of not less than 0.02 mm, and the welding layer 210 of the substrate layer 206 has a thickness of not less than 0.04 mm.

Referring back to FIGS. 1 to 11, the following will continue to describe a plurality of example embodiments of an inflatable pad 100.

FIGS. 1 to 3B show a first embodiment of an inflatable pad according to the present invention. Referring to FIG. 2 in connection with FIG. 3A, the illustrated inflatable pad 100 includes a connecting sheet 108 in addition to the top sheet 102 and the bottom sheet 104 described above. The connecting sheet 108 is disposed between the top sheet 102 and the bottom sheet 104 within the inflatable chamber 106. Optionally, the connecting sheet 108 may be made of thermoplastic polyurethane elastomer (TPU), polyvinyl chloride (PVC), polyurethane (PU), or any of various other suitable polymer materials. The connecting sheet 108 includes a plurality of first welding regions 110 and a plurality of second welding regions 112 that may be evenly distributed. The plurality of first welding regions 110 and the plurality of second welding regions 112 may be staggered from each other. In other words, in a vertical cross sectional cut, as shown in FIG. 3A, the locations of first welding regions 110 and the second welding regions 112 in the vertical direction do not overlap with each other. The plurality of first welding regions 110 are welded to the inner side of the top sheet 102, and the plurality of second welding regions 112 are welded to the inner side of the bottom sheet 104. In other words, a plurality of welding joints of the connecting sheet 108 and the top sheet 102 and a plurality of welding joints of the connecting sheet 108 and the bottom sheet 104 may be staggered from each other. Staggering the welding joints may contribute to preventing insufficient welding strength which may be caused by multiple welds at a same location of the connecting sheet 108.

The inflatable pad 100 may also include one or more layers disposed within the inflatable chamber 106 that provide for thermal insulation of the inflatable pad 100. In the illustrated example embodiment, the inflatable pad 100 includes two thermal insulation sheets, namely, a first thermal insulation sheet 114a and a second thermal insulation sheet 114b (also collectively referred to herein as thermal insulator 114). In the illustrated embodiment, the first thermal insulation sheet 114a is disposed between the top sheet 102 and the connecting sheet 108 in the inflatable chamber 106, and the second thermal insulation sheet 114b is disposed between the connecting sheet 108 and the bottom sheet 104 in the inflatable chamber 106. It is to be appreciated that, either or both of the thermal insulation sheets 114a, 114b may be omitted or two or more thermal insulation sheets may be included between the top sheet 102 and the connecting sheet 108 or between the bottom sheet 104 and the connecting sheet 108. In various embodiments, one or more thermal insulation sheets 114a may be included between the top sheet 102 and the connecting sheet 108, with no thermal insulation sheet 114b between the bottom sheet 104 and the connecting sheet 108, or one or more thermal insulation sheets 114b may be included between the bottom sheet 104 and the connecting sheet 108 with no thermal insulation sheet 114a between the top sheet 102 and the connecting sheet 108.

FIG. 3B illustrates an exemplary thermal insulation sheet 114x, which in various embodiments may comprise one of the individual thermal insulation sheets of the thermal insulator 114 (for example, one of the thermal insulation sheets 114a and/or 114b). Thermal insulation sheet 114x may include a polymer substrate 116 and a metal coating layer 118 applied to at least one of the two opposite sides of the polymer substrate 116. In the illustrated example embodiment, the thermal insulation sheet 114x includes polymer substrate 116 and a metal coating layer 118 applied to each of the two opposite sides of the polymer substrate 116. In further example embodiments, the thermal insulation sheet 114x may include a metal coating layer 118 on only one of the two opposite sides of the polymer substrate 116. The polymer substrate 116 of the thermal insulation sheet 114x may be formed of a suitable polymer material such as polyvinyl chloride (PVC), polypropylene (PP), polyethylene terephthalate (PET), polyamide (PA). The metal coating layer 118 of the thermal insulation sheet 114x may be formed of a suitable metal material such as aluminum, zinc, copper, silver, or gold. And in yet another embodiment, the polymer substrate 116 of the thermal insulation sheet 114x may be formed of polyethylene terephthalate (PET) and the metal coating layer 118 of the thermal insulation sheet 114x may be formed of aluminum.

To facilitate the welding of the top sheet 102 and the connecting sheet 108, the first thermal insulation sheet 114a may include a plurality of first openings 120a. The first openings 120a may be evenly distributed. The first openings 120a may provide apertures to connect neighboring cavities, a size of which apertures is small compared to the area of the first thermal insulation sheet 114a, which separates the cavities. Thereby, air transfer and heat transfer between the neighboring cavities is reduced. Each first opening 120a is configured to allow a corresponding one of the first welding regions 110 of the connecting sheet 108 to make contact with and be welded to the inside of the top sheet 102. To facilitate the welding of the connecting sheet 108 and the bottom sheet 104, the second thermal insulation sheet 114b includes a plurality of second openings 120b. The second openings 120b may be evenly distributed. The second openings 120b provide an aperture to connect neighboring cavities, a size of which apertures is small compared to the area of the second thermal insulation sheet 114b, which separates the cavities. Thereby, air transfer and heat transfer between the neighboring cavities is reduced. Each second opening 120b is configured to allow a corresponding one of the second welding regions 112 of the connecting sheet 108 to make contact with and be welded to the inside of the bottom sheet 104. Thus, the plurality of first welding regions 110 of the connecting sheet 108 can make contact with and be welded to the top sheet 102 via the plurality of first openings 120a, and the plurality of second welding regions 112 of the connecting sheet 108 can make contact with and be welded to the bottom sheet 104 via the plurality of second openings 120b.

FIG. 4 shows a schematic exploded view a second example embodiment of an inflatable pad 100. All explanations above apply accordingly, unless they contradict newly mentioned features of this example embodiment. Referring to FIG. 4, the inflatable pad 100 includes a plurality of tensioning members 122 in addition to the top sheet 102 and the bottom sheet 104 described above. The plurality of tensioning members 122 are disposed in the inflatable chamber 106 and spaced apart along a longitudinal direction L1 of the inflatable pad 100. The arrangement of the tensioning members 122 may be regular or irregular. At least one of the tensioning members 122 may have a reduced length compared to one or more other tensioning members 122. It is to be appreciated that, in further example embodiments, the plurality of tensioning members 122 may be spaced apart along a transverse direction perpendicular to the longitudinal direction of the inflatable pad 100. Further alternatively, the plurality of tensioning members 122 may be spaced apart along an angled direction, i.e. a direction neither perpendicular to the vertical nor to the longitudinal direction of the inflatable pad 100. In the illustrated example embodiment, each tensioning member 122 has a sheet shape, and a top edge 124 and a bottom edge 126 of each tensioning member 122 are connected to the top sheet 102 and the bottom sheet 104, respectively, for example by welding, to aid in maintaining the predetermined shape of the inflatable pad 100 while in the inflated state. Optionally, the tensioning member 122 may be constructed from a suitable polymer material such as polyvinyl chloride (PVC), polyurethane (PU), or thermoplastic polyurethane elastomer (TPU). The tensioning member 122 may be constructed from polyamide fiber (also referred to as nylon fiber) or polyethylene terephthalate fiber (PET fiber). The tensioning member 122 may be constructed from the aforementioned sheet 200 or a substrate layer 206 of the aforementioned sheet 200.

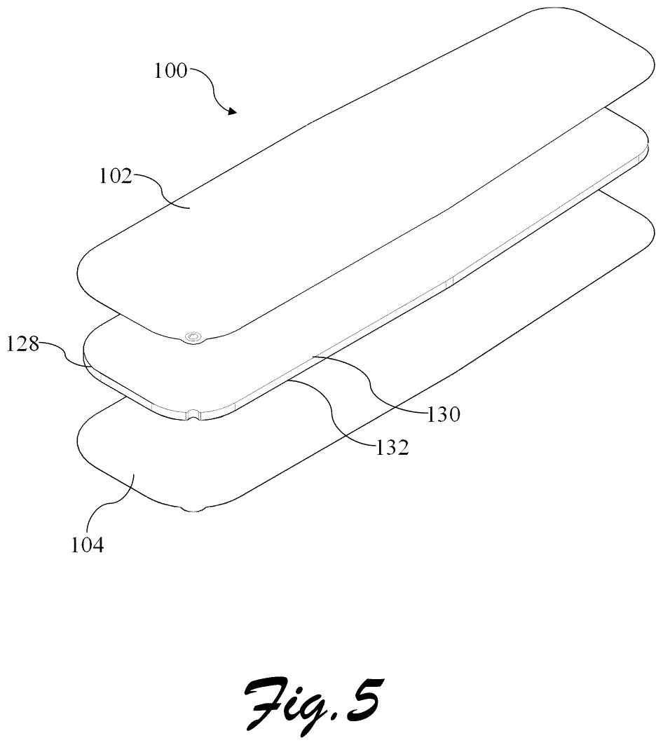

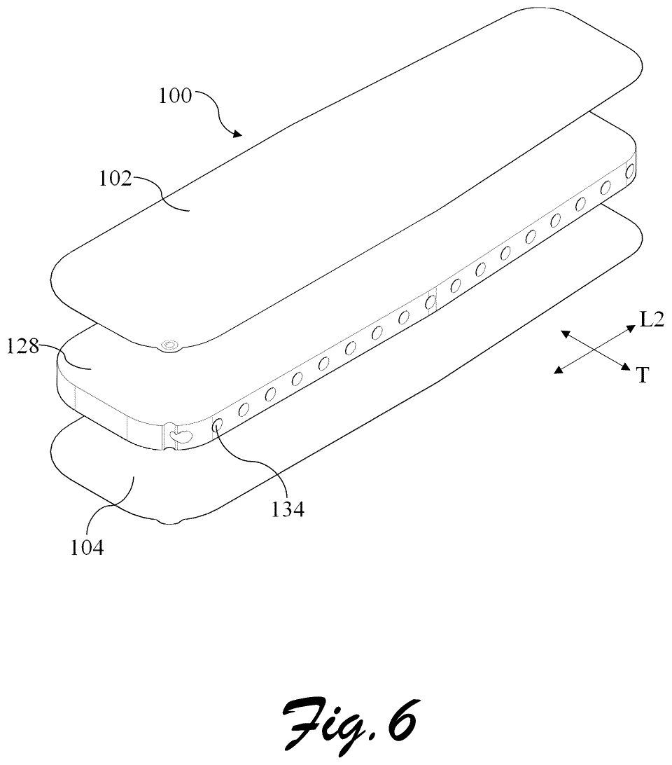

FIG. 5 shows a schematic exploded view of a third embodiment of an inflatable pad 100 according to the present invention. All explanations above apply accordingly, unless they contradict newly mentioned features of this embodiment. Referring to FIG. 5, the inflatable pad 100 includes a foam core 128 in addition to the top sheet 102 and the bottom sheet 104 described above. The foam core 128 is disposed within the inflatable chamber 106. The top sheet 102 may be laminated to a top surface 130 of the foam core 128, and the bottom sheet 104 may be laminated to a bottom surface 132 of the foam core 128. In various embodiments, the top sheet 102 and/or the bottom sheet 104 may be laminated to the top surface 130 and/or the bottom surface 132 of the foam core 128 by hot pressing or gluing.

If compressed under an external force, the foam core 128 may restore itself to its original shape after the external force is removed. The foam core 128 may, for example, be made of a lightweight and resilient open-cell foam material. The shape and volume of the foam core 128 may substantially match the shape and volume of the inflatable chamber 106 of the inflatable pad 100 in the inflated state. Alternatively, the shape and/or volume of the foam core 128 may only partially correspond to the shape and/or volume of the inflatable chamber 106 of the inflatable pad 100 in the inflated state. An example inflatable pad 100 thus constructed contributes to enabling the inflatable pad 100 to be rolled and/or folded into a relatively compact shape to exhaust the gas from the inflatable chamber 106. The compact shape may be a roll or a box-like shape. After compaction, an inflation valve of the inflatable pad 100 may be translated into a closed position so that the inflatable pad 100 can be stored in a small volume. While being prepared for use, the inflation valve may be translated to an open position and an expansion force of the foam core 128 will aid in deploying the inflatable pad 100 while drawing air into the inflatable chamber 106 of the inflatable pad 100. In other words, by incorporating the foam core 128, the inflatable pad 100 may be made to be self-inflatable. It is to be understood that the inflatable pad 100 may alternately be inflated by blowing air into it or by using an airbag or an air pump. Optionally, the foam core 128 may only fill a portion of the inflatable pad 100. For example, the foam core 128 may fill at least one fourth of the cavity of the inflatable pad 100. According to another example, the foam core 128 may fill half of the cavity of the inflatable pad 100 or may fill three fourths of the cavity of the inflatable pad 100. Optionally, the filling is distributed evenly.

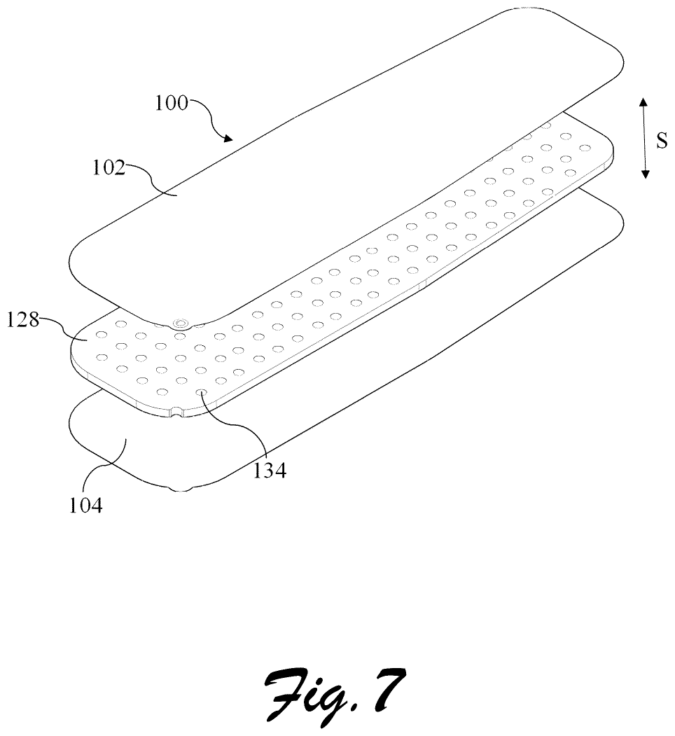

FIG. 6 shows a schematic exploded view of a fourth example embodiment of an inflatable pad 100. All explanations above apply accordingly, unless they contradict newly mentioned features of this example embodiment. The inflatable pad 100 in FIG. 6 is similar to the inflatable pad 100 in FIG. 5, except that the foam core 128 of the inflatable pad 100 in FIG. 6 includes a plurality of apertures 134. The apertures 134 may extend in a transverse direction T of the foam core 128. The apertures 134 may be uniformly distributed. In the example embodiment shown in FIG. 6, the plurality of apertures 134 penetrate the foam core 128 in the transverse direction T of the foam core 128 and are evenly spaced apart in a longitudinal direction L2 of the foam core 128. In the example embodiment shown in FIG. 6, the cross-section of each aperture 134 has an approximately circular shape. It is to be appreciated that, in further example embodiments, the plurality of apertures 134 may be blind apertures extending in the transverse direction of the foam core 128; in still further example embodiments, the plurality of apertures 134 may be through-holes or blind apertures extending in the longitudinal direction of the foam core 128; and in still further example embodiments, the cross-section of the apertures 134 may have other suitable shapes such as an oval shape or a polygonal shape. The diameter of an aperture 134 may be between about 20% and about 80% of the thickness of the foam core 128 in a thickness direction. For example, the diameter may be between 30% and 70%. Alternately, the diameter may be between 45% and 60%. Advantages provided by the perforated foam core 128 of FIG. 6 include a reduction in weight of the inflatable pad 100 compared to embodiments using a solid foam core, and enhanced softness of the inflatable pad 100 arising from easier deformation of the shape of the assembled inflatable pad 100 when a force is applied from a vertical direction.

FIG. 7 shows a schematic exploded view of a fifth example embodiment of an inflatable pad 100 according to the present invention. All explanations above apply accordingly, unless they contradict newly mentioned features of this example embodiment. The inflatable pad 100 in FIG. 7 is similar to the inflatable pad in FIG. 5, except that the foam core 128 of the inflatable pad 100 in FIG. 7 includes a plurality of apertures 134 that extend in a thickness direction S of the foam core 128. The apertures 134 may be uniformly distributed. In the example shown in FIG. 7, the plurality of apertures 134 penetrate the foam core 128 along the thickness direction S of the foam core 128 and are uniformly distributed in the foam core 128 in an array pattern. In the example embodiment shown in FIG. 7, the cross-section of each aperture 134 has a circular shape. It is to be appreciated that, in further example embodiments, the plurality of apertures 134 may be blind apertures extending in the thickness direction of the foam core 128; and in still further example embodiments, the cross-section of the apertures 134 may have other suitable shapes such as an oval shape or a polygonal shape. The diameter of an aperture 134 may be between about 20% and about 200% of the thickness of the foam core 128 in thickness direction S. For example, the diameter may be between 50% and 150%. Alternately, the diameter may be between 80% and 120%. Similarly to FIG. 6, advantages provided by the perforated foam core 128 of FIG. 7 include a reduction in weight of the inflatable pad 100 compared to embodiments using a solid foam core, and enhanced softness of the inflatable pad 100 arising from easier deformation of the shape of the assembled inflatable pad 100 when a force is applied from a vertical direction (i.e., in the “S” direction).

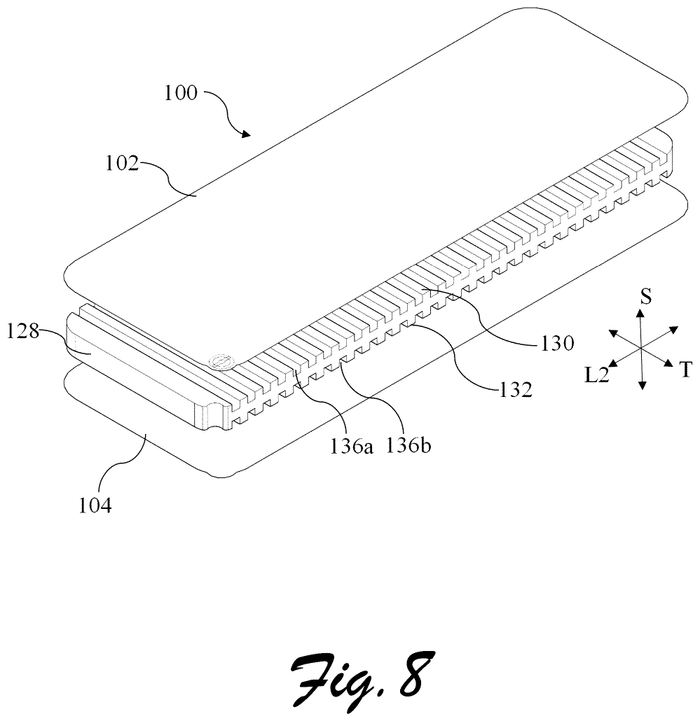

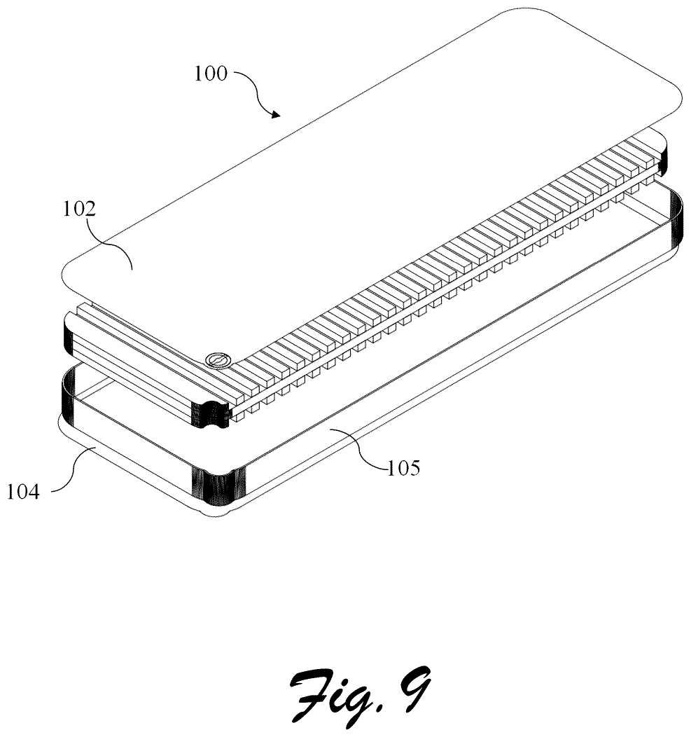

FIG. 8 shows a schematic exploded view of a sixth example embodiment of an inflatable pad 100 according to the present invention. All explanations above apply accordingly, unless they contradict newly mentioned features of this example embodiment. The inflatable pad 100 in FIG. 8 is similar to the inflatable pad 100 in FIG. 5, except that the foam core 128 of the inflatable pad 100 in FIG. 8 includes a plurality of uniformly distributed grooves 136a and 136b. The plurality of grooves may comprise a plurality of first grooves 136a recessed with respect to the top surface 130 of the foam core 128 and/or a plurality of second grooves 136b recessed with respect to the bottom surface 132 of the foam core 128. In the example embodiment shown in FIG. 8, the plurality of first grooves 136a extend in the transverse direction T of the foam core 128 and are spaced apart in the longitudinal direction L2 of the foam core 128. The plurality of first grooves 136a and/or the plurality of second grooves 136b may be evenly spaced apart. The plurality of second grooves 136b extend in the transverse direction T of the foam core 128 and are spaced apart in the longitudinal direction L2 of the foam core 128. At least one of the first grooves 136a is aligned with a corresponding one of the second grooves 136b in the thickness direction S of the foam core 128. Optionally, each of the first grooves 136a may be aligned with a corresponding one of the second grooves 136b in the thickness direction S of the foam core 128. The extension of a grooves 136a, 136b may be between about 20% and about 80% of the thickness of the foam core 128 in the thickness direction S. For example, the extension may be between 30% and 70%, or may be between 45% and 60%. As already indicated above, the distribution of the grooves 136a, 136b and/or the extension of the grooves 136a, 136b may contribute to a strength of the inflatable pad 100 in certain regions. Such regions may be a head-region and/or a central-region.

It is to be appreciated that, in further example embodiments, the first grooves 136a also may not be aligned with the second grooves 136b in the thickness direction S of the foam core 128; in still further example embodiments, the foam core 128 may be provided with a plurality of grooves 136a only recessed with respect to its top surface 130 or with a plurality of grooves 136b only recessed with respect to its bottom surface 132; and in still further example embodiments, the plurality of grooves may extend in the longitudinal direction L2 of the foam core 128.

By incorporating a plurality of apertures or a plurality of grooves, the weight of the inflatable pad 100 may be reduced without significantly altering its volume, making the inflatable pad 100 more portable; and alternatively, if the weight of the inflatable pad 100 remains relatively unchanged, increasing its thickness can offer users more comfortable support. In addition, the foam core 128 with apertures and grooves, after being made into an inflatable pad 100, may impart patterns on the surface of the inflatable pad 100, enhancing the visual appeal of the inflatable pad 100. Patterns imparted by a foam core 128 may be largely different of patterns formable by an inflatable product without a foam core 128, thereby increasing the diversity of patterns and/or shapes of the inflatable products.

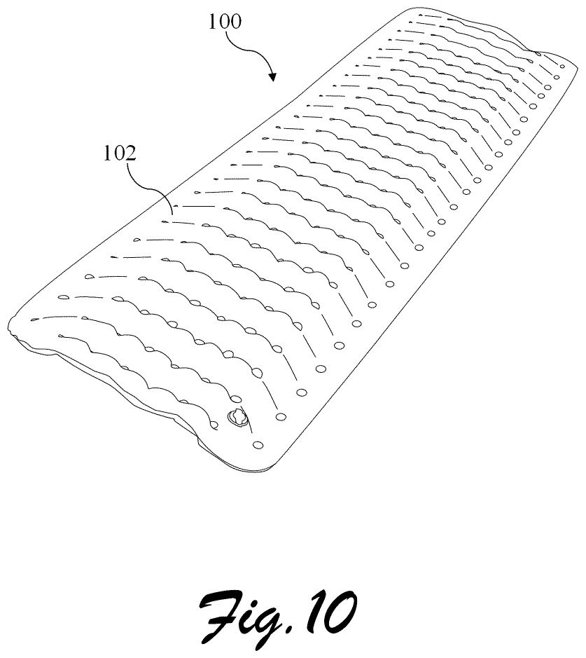

FIG. 9 shows a schematic exploded view of a seventh example embodiment of an inflatable pad 100 according to the present invention. All explanations above apply accordingly, unless they contradict newly mentioned features of this example embodiment. The inflatable pad 100 in FIG. 9 is similar to the inflatable pad 100 in FIG. 8, except that the inflatable pad 100 of FIG. 9 includes a top sheet 102, a bottom sheet 104, and a lateral sheet 105. The periphery of the top sheet 102 is connected to the lateral sheet 105, and the periphery of the bottom sheet 104 is connected to the lateral sheet 105, such that the periphery of the top sheet 102 is connected to the periphery of the bottom sheet 104 by means of the lateral sheet 105, and the top sheet 102, the bottom sheet 104, and the lateral sheet 105 jointly define the inflatable chamber 106. In the illustrated example embodiment, the periphery of the top sheet 102 is welded to a top edge of the lateral sheet 105, and the periphery of the bottom sheet 104 is welded to a bottom edge of the lateral sheet 105. The lateral sheet 105 may extend in a thickness direction an approximate thickness of the foam core 128, i.e., a height of the foam core 128. In this way, the inflatable pad 100 may have a rectangular cross-sectional shape. Alternatively, the lateral sheet 105 may extend in the thickness direction a distance smaller than the height of the foam core 128. In this way, the inflatable pad 100 may have a rectangular cross-sectional shape with rounded edges. Alternatively, the lateral sheet 105 may extend in thickness direction a distance larger than the height of the foam core 128. In this way, the inflatable pad 100 may have a concave cross-sectional shape on at least one side. This may aid in the inflatable pad 100 maintaining a person in the middle of the inflatable pad 100 during sleep. It is to be understood that the lateral sheet 105 of the seventh example embodiment may be included in a same manner in one or more other example embodiments described herein.

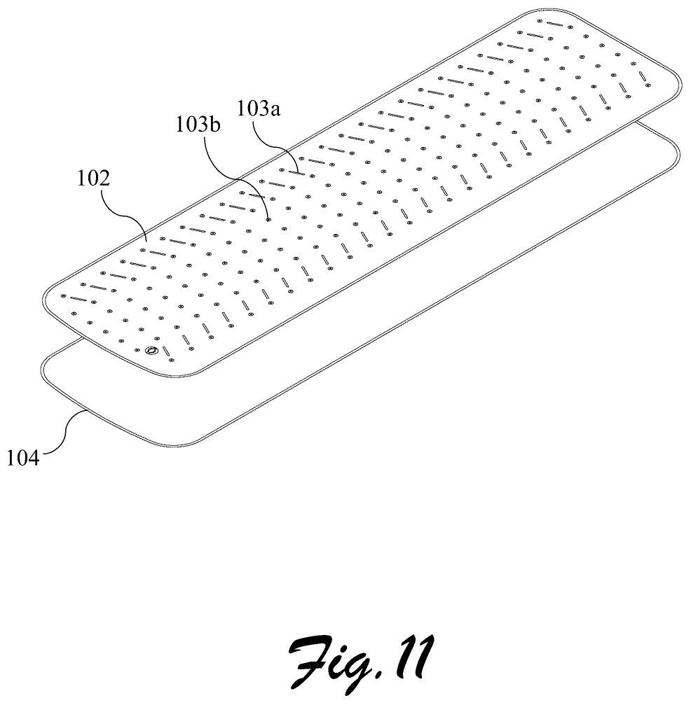

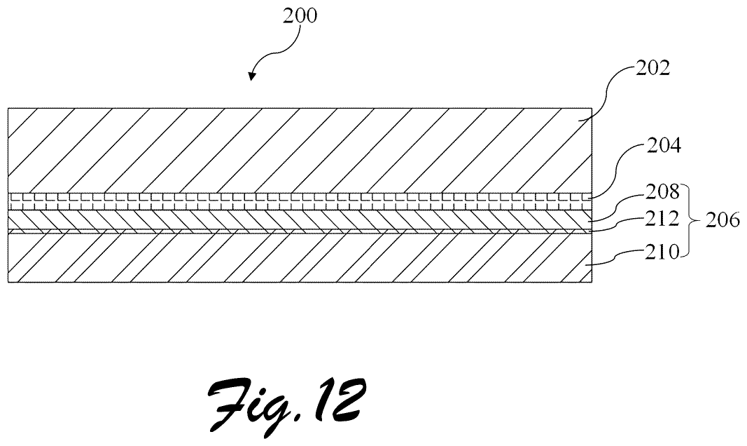

FIGS. 10 and 11 show an eighth example embodiment of an inflatable pad 100. All explanations above apply accordingly, unless they contradict newly mentioned features of this example embodiment. The non-limiting example of the inflatable pad 100 in FIGS. 10 and 11 mainly differs from the inflatable pad 100 in FIGS. 1 and 2 in that no other components are provided in the inflatable chamber 106 defined by the top sheet 102 and the bottom sheet 104 of the inflatable pad 100 in FIGS. 10 and 11. Further, the top sheet 102 may be directly welded to the bottom sheet 104 at a plurality of weld lines 103a and a plurality of weld points 103b which are distributed, such that the inflatable pad 100 maintains a predetermined shape in the inflated state. The weld lines 103a and/or the weld points 103b may be uniformly distributed.

It should be understood that the example embodiments shown in FIGS. 1 to 11 only show the shapes, dimensions and arrangements of the various optional components of the inflatable pad 100 according to the present invention, which, however, are only illustrative and not limiting, and other shapes, dimensions and arrangements may be employed without departing from the spirit and scope of the described example embodiments.

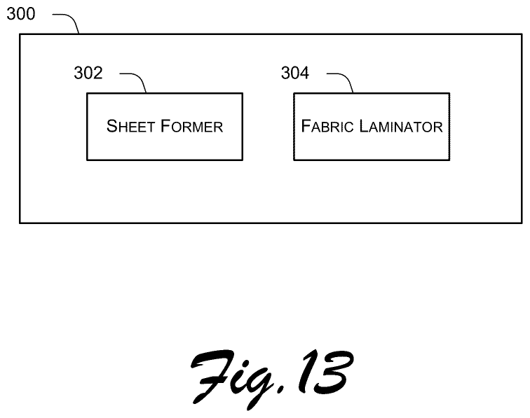

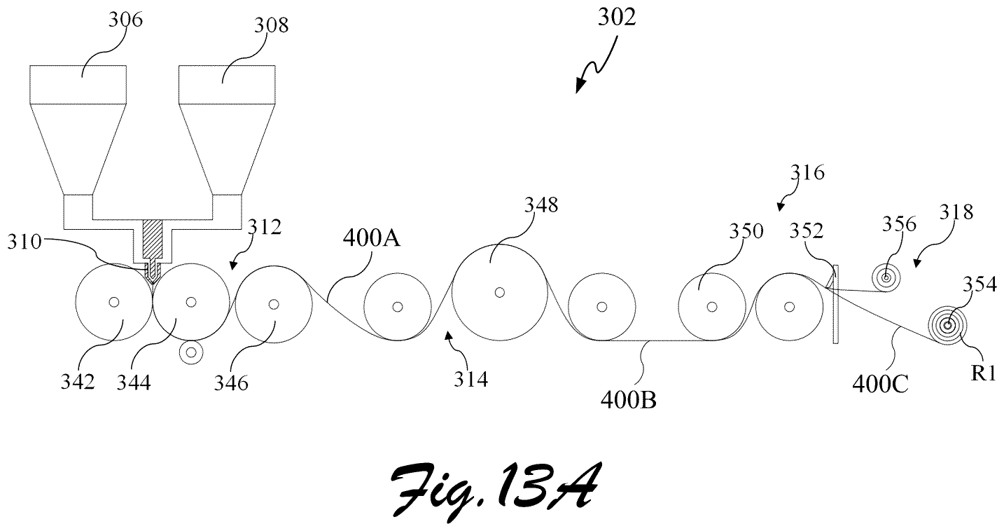

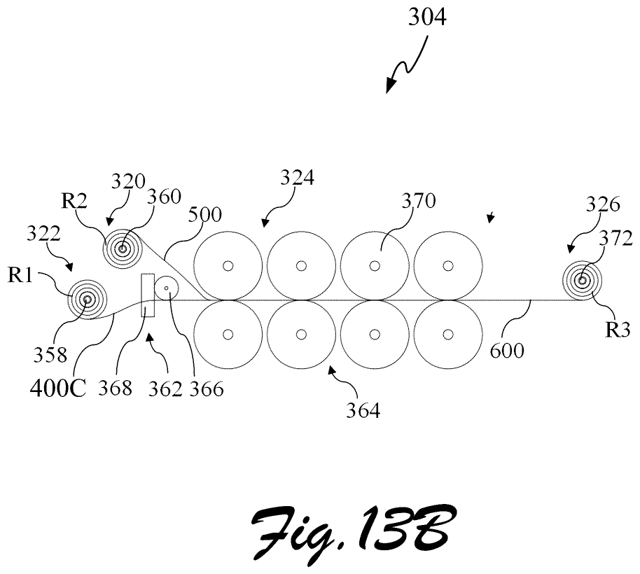

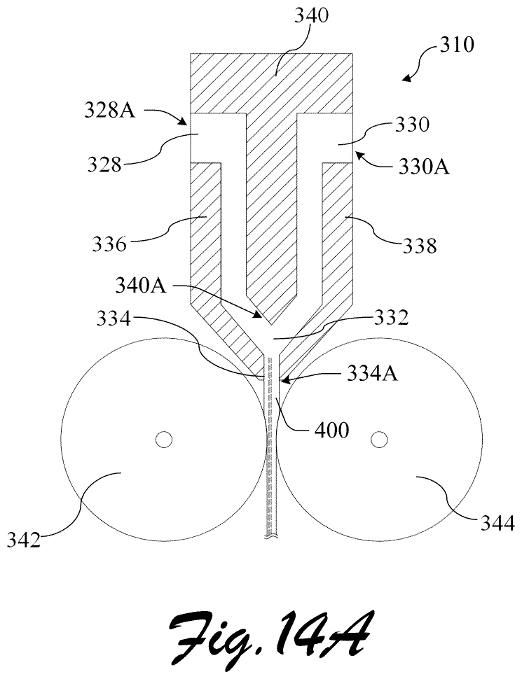

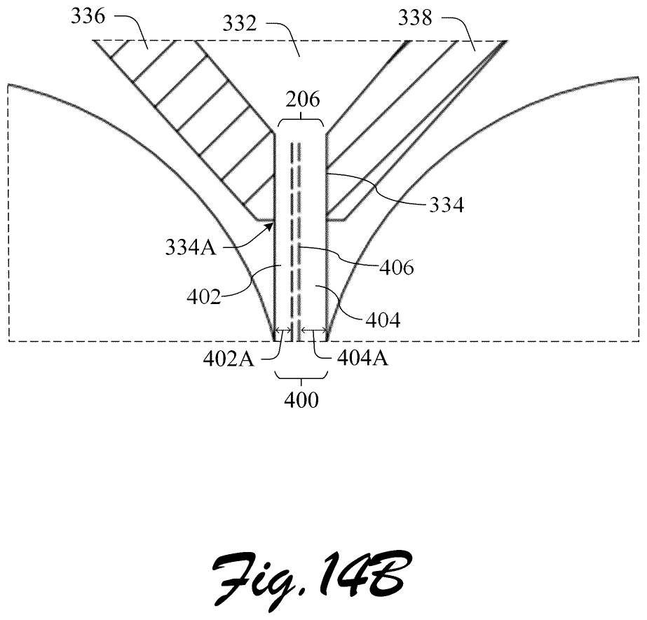

FIGS. 13A to 13B show schematic diagrams of a first example embodiment of a sheet manufacturing apparatus 300 of FIG. 13 according to the present invention, which may be used to manufacture the sheet 200 shown in FIG. 12. FIG. 14A is an enlarged partial cross-sectional schematic view of the sheet former 302 of the sheet manufacturing apparatus 300 of FIG. 13A, and FIG. 14B is an even further enlarged partial cross-sectional schematic view of the die outlet 334 of FIG. 14A.

Initially, referring to FIGS. 13, 13A and 13B, in the example embodiment, the sheet manufacturing apparatus 300 may include a sheet former (FIG. 13A, 302) and a fabric laminator (FIG. 13B, 304) that may be separated from each other. The sheet former 302 may include: a first feed hopper 306, a second feed hopper 308, a sheet extrusion die 310, a pressing device 312, a cooling device 314, a trimming device 316, and a first winding device 318. The fabric laminator 304 may include: a third feeding device 320, an unwinding device 322, a lamination device 324, and a second winding device 326.

In the sheet former 302 of the sheet manufacturing apparatus 300, the first feed hopper 306 is in communication with the sheet extrusion die 310 and may supply a first polymer material in a flowable state to the sheet extrusion die 310; and the second feed hopper 308 is in communication with the sheet extrusion die 310 and may supply a second polymer material in a flowable state to the sheet extrusion die 310. The first and second feed hoppers 306, 308 may be of equal size or the relative sizes of the first and second feed hoppers 306, 308 may be adopted to the relative ratio of a thickness 402A of a barrier layer 402 to a thickness 404A of a welding layer 404. In an embodiment, a melting point of the first polymer material is higher than a melting point of the second polymer material. The first feed hopper 306 and the second feed hopper 308 may have heating assemblies to heat the first and second polymer materials to transform said materials from a solid state to a molten state, respectively, thereby making the first polymer material and the second polymer material flowable. Optionally, the first feed hopper 306 and/or the second feed hopper 308 may have a screw conveying mechanism that enables the material to be sufficiently plasticized and evenly mixed and spirally transported along an axial direction of the screw by means of the pressure and shear force generated by the rotation of the screw. It is to be understood that those skilled in the art may employ any of various other forms of conveying mechanisms according to actual needs. As an example, although not limited to it, the first feed hopper 306 and/or the second feed hopper 308 may have a gear pump conveying mechanism.

Referring to FIGS. 14A and 14B, wherein the previous descriptions apply accordingly, subsequently, the first polymer material and the second polymer material in the flowable state converge in the sheet extrusion die 310. The sheet extrusion die 310 includes a first flow channel 328, a second flow channel 330, a Y-shaped converging chamber 332, and a die outlet 334. Each of the first flow channel 328, the second flow channel 330, and the die outlet 334 is in communication with the converging chamber 332. The first flow channel 328 and the second flow channel 330 are configured for delivering the first polymer material in the flowable state and the second polymer material in the flowable state, respectively, into the converging chamber 332. The converging chamber 332 is disposed to enable the first and second polymer materials in the flowable state to converge and make contact within the converging chamber 332. Subsequently, the converged first and second polymer materials are extruded from the die outlet 334 to form a formed material sheet 400.

More particularly, the first polymer material in the flowable state from the first feed hopper 306 flows into the first flow channel 328 through an inlet 328A of the first flow channel 328 and flows into the converging chamber 332 through the first flow channel 328, and the second polymer material in the flowable state from the second feed hopper 308 flows into the second flow channel 330 through an inlet 330A of the second flow channel 330 and flows into the converging chamber 332 through the second flow channel 330. The first and second polymer materials in the flowable state then converge in the converging chamber 332, and the converged materials enter the die outlet 334 from the converging chamber 332 and are extruded from the die outlet 334 to create the formed material sheet 400, the formed material sheet 400 including a barrier layer 402 formed of the first polymer material and a welding layer 404 formed of the second polymer material.

The first polymer material in the flowable state from the first flow channel 328 and the second polymer material in the flowable state from the second flow channel 330 may at least partially mix in the converging chamber 332, that when extruded from the die outlet 334, creates a formed material sheet 400 that includes: the barrier layer 402 formed of the first polymer material, the welding layer 404 formed of the second polymer material, and an intermediate layer 406 formed of a mixture of the first polymer material and the second polymer material. The first and second polymer materials may be mixed at their interface such that a continuous intermediate layer is present between barrier layer 402 and welding layer 404. The intermediate layer 406 of the formed material sheet 400 is located between the barrier layer 402 and the welding layer 404 and enables the barrier layer 402 and the welding layer 404 to be more completely bonded. It should be understood that in various embodiments there may be no obvious interface between the barrier layer 402 and the intermediate layer 406 of the formed material sheet 400 and between the welding layer 404 and the intermediate layer 406.

Referring to FIG. 14A, the sheet extrusion die 310 may be assembled from at least a first die chamber housing 336, a second die chamber housing 338, and a die channel merge body 340. The first die chamber housing 336 and the die channel merge body 340 may define there between one or more of a first flow channel 328 in communication with the converging chamber 332. For example, the first die chamber housing 336 and the die channel merge body 340 may abut against each other, and at least one of the first die chamber housing 336 and the die channel merge body 340 may be provided with one or more recesses in an area of contact, thereby forming the aforementioned one or more first flow channels 328. Similarly, the second die chamber housing 338 and the die channel merge body 340 may define there between one or more second flow channels 330 in communication with the converging chamber 332. For example, the second die chamber housing 338 and the die channel merge body 340 may abut against each other, and at least one of the second die chamber housing 338 and the die channel merge body 340 may be provided with one or more recesses in an area of contact, thereby forming the aforementioned one or more second flow channels 330. The die outlet 334 of the sheet extrusion die 310 may be defined by at least the first die chamber housing 336 and the second die chamber housing 338 and may comprise a slot-shaped orifice referred to as die orifice 334A. The shape and internal dimensions of die orifice 334A of the die outlet 334 defines the size and shape of the formed material sheet 400 extruded from the die outlet 334.

Referring additionally to FIG. 14B, placement and shape of the die channel merge body 340 with respect to the first die chamber housing 336 and the second die chamber housing 338 allows selection of a relative thickness ratio of a barrier layer thickness 402A of the barrier layer 402 and a welding layer thickness 404A of the welding layer 404 of the formed material sheet 400. More specifically, to adjust a thickness ratio between the thicknesses 402A, 404A of respective barrier layer 402 and welding layer 404, the shape and placement of a protrusion 340A of the die channel merge body 340 may be adjusted with respect to the first and second die chamber housings 336, 338. For example, the protrusion 340A of the die channel merge body 340 facing the die outlet 334 may be shaped symmetrically with respect to the first and second die chamber housings 336, 338, thereby enabling formation of equally-sized first and second flow channels 328, 330, which may result in an approximate 1:1 thickness ratio between thicknesses 402A, 404A of the respective barrier and welding layers 402, 404 of the formed material sheet 400. Alternatively, the protrusion 340A of the die channel merge body 340 facing the die outlet 334, may be shaped unsymmetrically, thereby enabling formation of unequally-sized first and second flow channels 328, 330 which may result in a thickness ratio different from 1:1, such as ratios of, for example 1:2, 1:3 or 1:4, between thicknesses 402A, 404A of the respective barrier and welding layers 402, 404 of the formed material sheet 400. Further alternatively, the shape of the die channel merge body 340 including its protrusion 340A may be symmetrical, as mentioned above, and the thickness ratio between thicknesses 402A, 404A of the respective barrier layer 402 and welding layer 404 may be determined by varying respective pressures in the first and second flow channels 328, 330.

Referring additionally to FIGS. 13A and 13B, the formed material sheet 400 delivered from the die orifice 334A of the die outlet 334 is conveyed to the pressing device 312. The pressing device 312 is configured to apply a pressing force to the formed material sheet 400 delivered from the die orifice 334A to create a pressed material sheet 400A. The pressing may include flattening and/or embossing, such as flattening only, flattening and then embossing, or embossing only. In the illustrated example embodiment, the pressing device 312 may include a first roller 342 and a second roller 344 adjacent to the die orifice 334A of the die outlet 334 and a third roller 346 downstream of the first roller 342 and the second roller 344 in a conveying direction of the pressed material sheet 400A. The formed material sheet 400 delivered from the die orifice 334A enters between the first roller 342 and the second roller 344 and then travels to the third roller 346. Optionally, in an example embodiment in which the formed material sheet 400 is embossed by the pressing device 312, embossing may be implemented, for example, by arranging one of the first roller 342, the second roller 344, and the third roller 346 as an embossing roller. In an example embodiment in which the formed material sheet 400 is embossed, this arrangement may aid in preventing a problem where after the processed (e.g., cooled and trimmed) trimmed material sheet 400C is subsequently rolled into a trimmed material sheet roll R1 using the first winding device 318, adjacent layers of trimmed material sheet 400C in the trimmed material sheet roll R1 stick or adhere to each other, resulting in difficulties in the subsequent unwinding of the trimmed material sheet roll R1. Optionally, the pressing device 312 may also include a heating assembly to heat the first roller 342, the second roller 344, and the third roller 346. This heating arrangement helps to prevent a problem whereby the formed material sheet 400, which is still at a high temperature when delivered from the die orifice 334A, rapidly cools after entering the pressing device 312, resulting in defects and difficulty in flattening and/or embossing of the formed material sheet 400 due to the resultant reduced malleability of the cooled formed material sheet 400. Optionally, the first and second rollers 342 and 344 may be heated to a temperature below the temperature of the formed material sheet 400 delivered from the die orifice 334A of the die outlet 334, and the third roller 346 may be heated to a temperature below the temperature of the first and second rollers 342 and 344, allowing the formed material sheet 400 to undergo controlled preliminary cooling while being pressed by the pressing device 312.

The pressed material sheet 400A may be fed into the cooling device 314 for complete cooling to create a cooled material sheet 400B. The cooling device 314 may include a plurality of cooling rollers 348 to cool and solidify the cooled material sheet 400B for subsequent lamination with the fabric sheet 500. The cooled material sheet 400B may be cooled completely, for example, to an ambient temperature. The cooling device 314 may include a cooling assembly that conveys a low-temperature cooling medium into the cooling rollers 348 to cool the cooling rollers 348 to keep them at a low temperature. The temperature of the cooling medium may be below ambient temperature. Meanwhile, the cooling assembly recovers the heated cooling medium from the cooling rollers 348 and cools the heated cooling medium, and then conveys the low-temperature cooling medium back into the cooling rollers 348 in a continuous cycle. The cooling medium may be gas or liquid. For example, the cooling medium may be a liquid such as water or oil.

The cooled material sheet 400B may be fed into the trimming device 316 for trimming. The trimming device 316 may include a plurality of conveying rollers 350 and a cutting tool 352 to trim the cooled material sheet 400B into a predetermined width to create a trimmed material sheet 400C. The cutting tool 352 may be for example a cutting knife, a laser cutting head, or the like. The width of the trimmed material sheet 400C may be substantially equal to the width of a fabric sheet 500 to be laminated thereto, so that the trimmed material sheet 400C can be laminated to the fabric sheet 500 to obtain a finished sheet without further cutting or only a small amount of cutting of the resulting laminated material sheet 600. The first winding device 318 may include a first winding roller 354 and a second winding roller 356. The first winding roller 354 is used for winding the trimmed material sheet 400C to form the trimmed material sheet roll R1 for the subsequent lamination process. The second winding roller 356 is used for winding the offcuts generated from the trimming process.

The trimmed material sheet roll R1 is then fed into the fabric laminator 304 of the sheet manufacturing apparatus 300. The trimmed material sheet roll R1 may be unrolled by the unwinding device 322 to provide the trimmed material sheet 400C to the lamination device 324 while the third feeding device 320 provides the fabric sheet 500 to the lamination device 324. The lamination device 324 is configured to apply an adhesive material onto the fabric sheet 500 or the barrier layer 402 of the trimmed material sheet 400C, or to both the fabric sheet 500 and the trimmed material sheet 400C, and to laminate the fabric sheet 500 to the trimmed material sheet 400C through the adhesive material to form the laminated material sheet 600.

In the illustrated example embodiment, the unwinding device 322 includes an unwinding roller 358. In the illustrated example embodiment, the lamination device 324 includes a coating unit 362 and a lamination unit 364. Herein, the coating unit 362 may include a coating roller 366 and a coating thickness control assembly 368. The trimmed material sheet 400C may be delivered from the unwinding roller 358 into the coating unit 362, specifically beneath the coating roller 366, such that the barrier layer 402 of the trimmed material sheet 400C faces the coating roller 366. The adhesive material may be first applied from above between the coating roller 366 and the coating thickness control assembly 368 and then applied to the trimmed material sheet 400C via the coating roller 366. The thickness of the adhesive material attached to the coating roller 366 may be adjusted by adjusting the size of a gap between the coating thickness control assembly 368 and the coating roller 366, thereby controlling the thickness of the adhesive material applied to the trimmed material sheet 400C by the coating roller 366. Such a coating unit 362 is adapted to apply, for example, a PUR hot melt adhesive onto the trimmed material sheet 400C. In the case in which the adhesive material is a PUR hot melt adhesive, the coating unit 362 may also include a heating assembly to heat the solid PUR hot melt adhesive to a molten state, and then apply the molten/flowable PUR hot melt adhesive to the trimmed material sheet 400C. In the illustrated example embodiment, the trimmed material sheet 400C is fed into the coating unit 362 for adhesive application; and it is to be appreciated that, in alternate example embodiments, the fabric sheet 500 may be fed into the coating unit 362 for adhesive application and then laminated to the trimmed material sheet 400C.

In the illustrated example embodiment, the third feeding device 320 includes an unwinding roller 360 and the lamination unit 364 includes multiple pairs of oppositely disposed lamination rollers 370. A fabric roll R2 may be unwound by the unwinding roller 360 to feed the fabric sheet 500 between the oppositely disposed lamination rollers 370, and the trimmed material sheet 400C onto which the adhesive material has been applied is also fed between the opposing lamination rollers 370 such that the trimmed material sheet 400C and the fabric sheet 500 are laminated together by the adhesive material, for example under pressure, to form the laminated material sheet 600. The laminated material sheet 600 includes a fabric layer formed of the fabric sheet 500, an adhesive layer formed of the adhesive material, and a substrate layer 206 provided by the trimmed material sheet 400C, where the fabric layer is laminated to the substrate layer 206 of the trimmed material sheet 400C through the adhesive layer. A description of another structurally similar embodiment may be seen in FIG. 12 and the accompanying text.

The laminated material sheet 600 may be directly used as a finished sheet 200 without subsequent treatment, and is wound into a finished sheet roll R3 by the winding roller 372 of the second winding device 326. It is to be appreciated that, in further example embodiments, the laminated material sheet 600 may be subjected to subsequent processing such as trimming, shaping, and/or cleaning according to actual needs to form the finished sheet 200. Optionally, before the fabric sheet 500 is fed to the lamination device 324, the side of the fabric sheet 500 to be bonded to the trimmed material sheet 400C may be coated with a polyurethane coating, and then the fabric sheet 500 coated with the polyurethane coating may be laminated to the trimmed material sheet 400C by the adhesive material so as to contribute to enhancing the bonding effect of the fabric sheet 500 to the adhesive material, and to enhance the bonding strength of the fabric sheet 500 to the trimmed material sheet 400C. It is to be understood that this can also be applied to other example embodiments of the sheet manufacturing apparatus and sheet manufacturing method described herein. Optionally, a polyurethane mixture may be formed by mixing polyurethane resin and crosslinker in a ratio of, for example, approximately 100:2. The polyurethane mixture is then applied onto the surface of fabric sheet 500, followed by drying in an oven, to form a polyurethane coating on the surface of fabric sheet 500.

In the example embodiment shown in FIGS. 13A and 13B, the sheet former 302 and the fabric laminator 304 of the sheet manufacturing apparatus 300 are separated from each other. In further example embodiments, the sheet former 302 and the fabric laminator 304 of the sheet manufacturing apparatus 300 may be coupled to simplify the production process. For example, in some example embodiments, the sheet former 302 of the sheet manufacturing apparatus 300 may omit the first winding roller 354 for winding the trimmed material sheet 400C and the fabric laminator 304 may omit the unwinding device 322. The trimmed material sheet 400C formed by the sheet former 302 during sheet manufacturing may be directly fed into the lamination device 324 of the fabric laminator 304 for adhesive application and lamination.

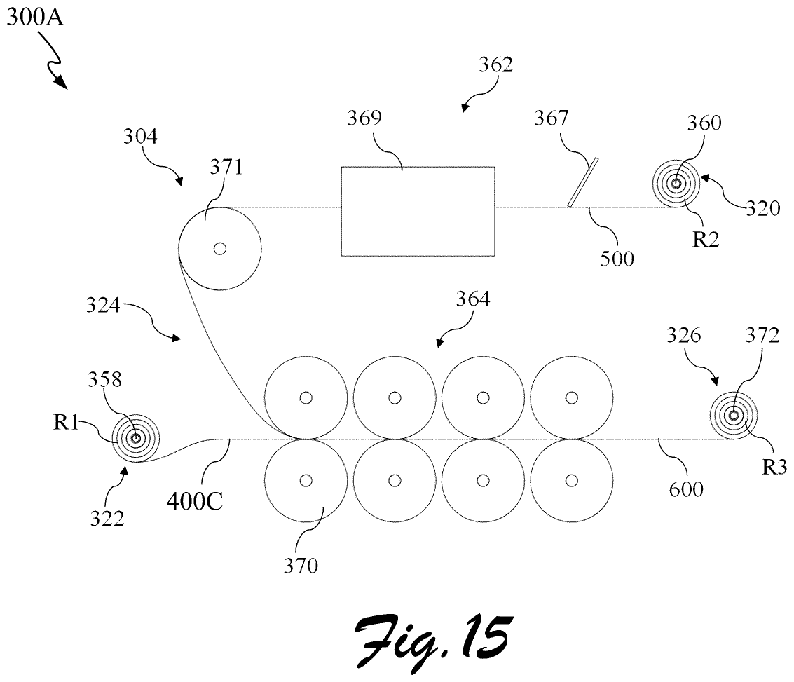

FIG. 15 shows a schematic diagram of the fabric laminator 304 of a second example embodiment of a sheet manufacturing apparatus 300A in which the sheet former 302 of the sheet manufacturing apparatus 300 is omitted. All explanations above apply accordingly, unless they contradict newly mentioned features of this embodiment. The second example embodiment of the sheet manufacturing apparatus has the same sheet former 302 as that of the first embodiment of the sheet manufacturing apparatus in FIGS. 13A to 14B, so that a trimmed material sheet roll R1 into which the trimmed material sheet 400C is wound can also be obtained by the sheet former 302 of the second example embodiment of the sheet manufacturing apparatus 300A.

The second example embodiment of the sheet manufacturing apparatus 300A as shown in FIG. 15 differs from the first example embodiment of the sheet manufacturing apparatus 300 in FIGS. 13 to 14B in that the lamination device 324 of the fabric laminator 304 of the sheet manufacturing apparatus of FIG. 15 is configured to apply the adhesive material onto the fabric sheet 500 prior to laminating the fabric sheet 500 to the trimmed material sheet 400C.

Referring to FIG. 15, the fabric laminator 304 may include: a third feeding device 320, an unwinding device 322, a lamination device 324, and a second winding device 326. The trimmed material sheet roll R1 may be fed into the fabric laminator 304 of the sheet manufacturing apparatus 300A. The trimmed material sheet roll R1 may be unrolled by the unwinding device 322 to provide the trimmed material sheet 400C to the lamination device 324, and the third feeding device 320 provides the fabric sheet 500 to the lamination device 324. The lamination device 324 is configured to apply an adhesive material onto the fabric sheet 500 and to laminate the fabric sheet 500 to the trimmed material sheet 400C through the adhesive material to form the laminated material sheet 600.

In the illustrated example embodiment, the third feeding device 320 includes an unwinding roller 360, the unwinding device 322 includes an unwinding roller 358, the lamination device 324 includes a coating unit 362 and a lamination unit 364, and the second winding device 326 includes a winding roller 372.

The coating unit 362 may include a scraper 367, an oven 369, and a conveying roller 371, and may be used to apply an adhesive material, such as a solvent-based PU adhesive or water-based PU adhesive, onto the fabric sheet 500. The operating principle of the coating unit 362 will be described below taking a solvent-based PU adhesive as an example. The fabric sheet 500 may be fed from the unwinding roller 360 into the coating unit 362, for example, beneath the scraper 367. The solvent-based PU adhesive mixture may be applied to one side of the scraper 367, and then the thickness of the adhesive mixture applied to the fabric sheet 500 by the scraper 367 may be controlled by adjusting the gap between the scraper 367 and the fabric sheet 500. The solvent-based PU adhesive mixture may be formed by mixing polyurethane resin and a crosslinker in certain proportions. Then, the fabric sheet 500 onto which the solvent-based PU adhesive mixture has been applied may be conveyed to the oven 369 for drying to form the fabric sheet 500 coated with the solvent-based PU adhesive, i.e., the coated fabric sheet 500.

The lamination unit 364 includes one or multiple pairs of oppositely disposed lamination rollers 370. The trimmed material sheet roll R1 may be unwound by the unwinding roller 358 to feed the trimmed material sheet 400C between the oppositely disposed lamination rollers 370, and the coated fabric sheet 500 is fed between the opposing lamination rollers 370 by the conveying roller 371 such that the trimmed material sheet 400C and the fabric sheet 500 are laminated together through the adhesive material, e.g. under pressure, to form the laminated material sheet 600. The laminated material sheet 600 includes a fabric layer formed of the fabric sheet 500, an adhesive layer formed of the adhesive material, and a substrate layer 206 of the trimmed material sheet 400C, the fabric layer being laminated to a barrier layer of the substrate layer 206 through the adhesive layer.

The laminated material sheet 600 may be directly used as a finished sheet 200 without subsequent treatment, and is wound into a finished sheet roll R3 by the winding roller 372 of the second winding device 326. It is to be appreciated that, in further example embodiments, the laminated material sheet 600 may be subjected to subsequent processing such as shaping and cleaning according to actual needs to form the finished sheet 200.

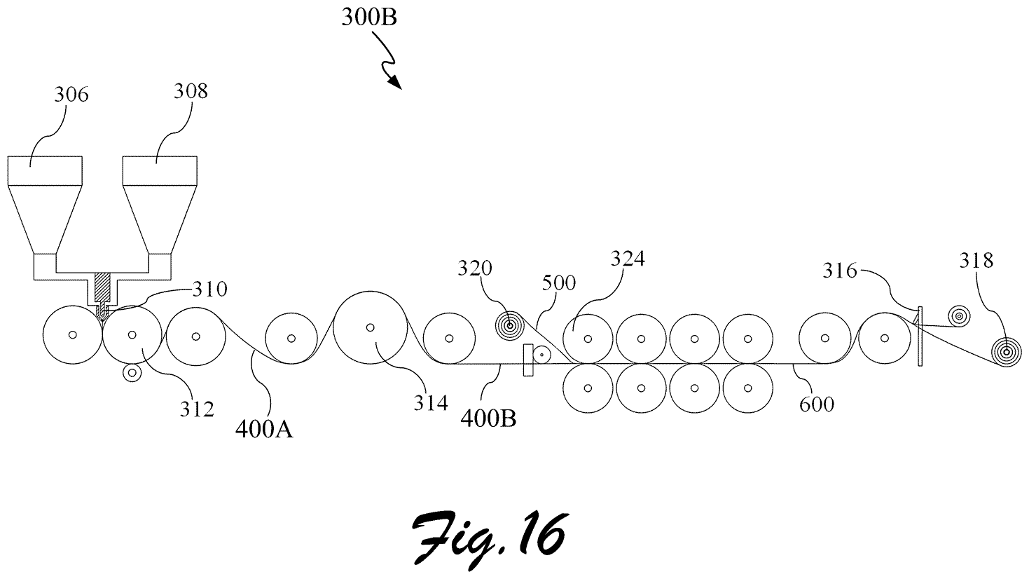

FIG. 16 shows a schematic diagram of a non-limiting third example embodiment of a sheet manufacturing apparatus 300B, which can be used to manufacture the sheet 200 shown in FIG. 12 and which eliminates the need for the winding and unwinding of the formed material sheet 400 during the manufacturing process. All explanations above apply accordingly, unless they contradict newly mentioned features of this example embodiment.

The sheet manufacturing apparatus 300B shown in FIG. 16 includes: a first feed hopper 306, a second feed hopper 308, a sheet extrusion die 310, a pressing device 312, a cooling device 314, a third feeding device 320, a lamination device 324, a trimming device 316, and a winding device 318. The first feed hopper 306, the second feed hopper 308, the sheet extrusion die 310, the pressing device 312, the cooling device 314, the third feeding device 320, the lamination device 324, the trimming device 316, and the winding device 318 of the sheet manufacturing apparatus 300 shown in FIG. 16 may have the same configurations as the first feed hopper, the second feed hopper, the sheet extrusion die, the pressing device, the cooling device, the third feeding device, the lamination device, the trimming device, and the first winding device, respectively, of the sheet manufacturing apparatus shown in FIGS. 13, 13A and 13B. The sheet manufacturing apparatus 300B shown in FIG. 16 differs from the sheet manufacturing apparatus 300 shown in FIG. 13A and FIG. 13B in that the sheet manufacturing apparatus 300B shown in FIG. 16 is configured to: convey the cooled material sheet 400B, cooled by the cooling device 314, directly to the lamination device 324 to be coated with the adhesive material and laminated to the fabric sheet 500 by the adhesive material to form a laminated material sheet 600; trim the laminated material sheet 600 with the trimming device 316; and wind the trimmed laminated material sheet 600 with the winding device 318 and winding the offcuts generated from the trimming process.

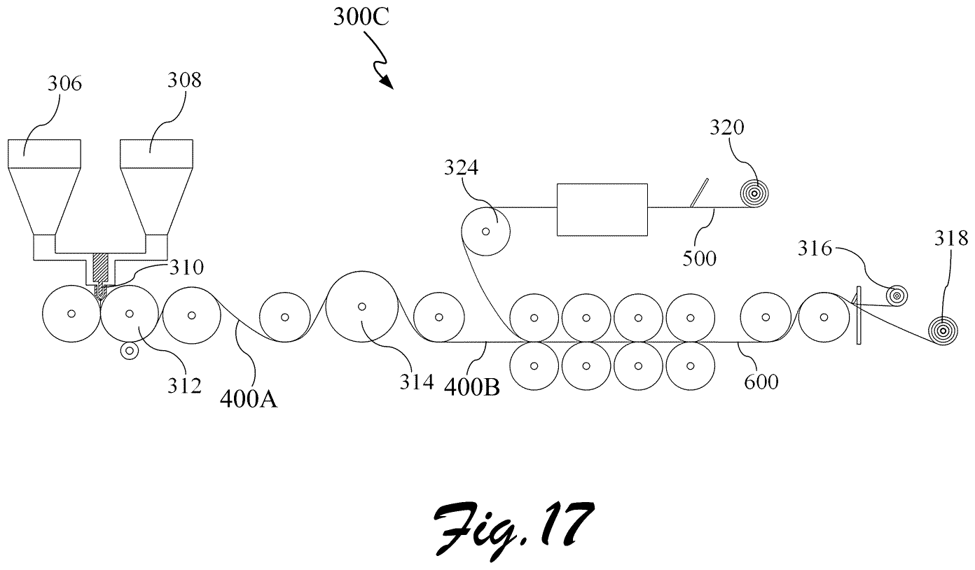

FIG. 17 shows a schematic diagram of a fourth example embodiment of a sheet manufacturing apparatus 300C. All explanations above apply accordingly, unless they contradict newly mentioned features of this example embodiment. The sheet manufacturing apparatus 300C in FIG. 17 is similar to the sheet manufacturing apparatus 300B in FIG. 16. The sheet manufacturing apparatus 300C in FIG. 17 mainly includes: a first feed hopper 306, a second feed hopper 308, a sheet extrusion die 310, a pressing device 312, a cooling device 314, a third feeding device 320, a lamination device 324, a trimming device 316, and a winding device 318. The sheet manufacturing apparatus 300C in FIG. 17 differs from the sheet manufacturing apparatus 300B in FIG. 16 in that the lamination device 324 of the sheet manufacturing apparatus 300C in FIG. 17 is configured to apply the adhesive material onto the fabric sheet 500 prior to laminating the fabric sheet 500 to the cooled material sheet 400B. The lamination device 324 of the sheet manufacturing apparatus 300C in FIG. 17 has the same configuration as that of the lamination device 324 in FIG. 15, and may be used to apply an adhesive material such as solvent-based PU adhesive or water-based PU adhesive onto the fabric sheet 500. Then, the fabric sheet 500 is laminated, after the adhesive application, to the cooled material sheet 400B to form a laminated material sheet 600.

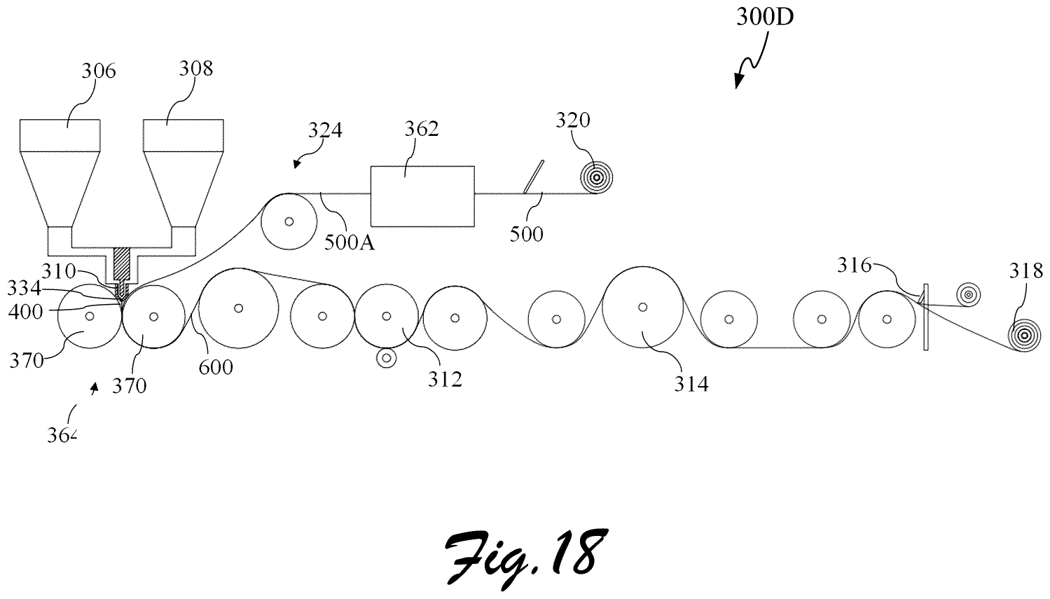

FIG. 18 shows a schematic diagram of a fifth example embodiment of a sheet manufacturing apparatus 300D. All explanations above apply accordingly, unless they contradict newly mentioned features of this example embodiment. The sheet manufacturing apparatus 300D in FIG. 18 is similar to the sheet manufacturing apparatus 300C in FIG. 17. The sheet manufacturing apparatus 300D in FIG. 18 mainly includes: a first feed hopper 306, a second feed hopper 308, a sheet extrusion die 310, a third feeding device 320, a lamination device 324, a pressing device 312, a cooling device 314, a trimming device 316, and a winding device 318.

The sheet manufacturing apparatus 300D in FIG. 18 differs from the sheet manufacturing apparatus 300C in FIG. 17 mainly in that the sheet manufacturing apparatus 300 in FIG. 18 is configured to feed the formed material sheet 400 that is formed by the sheet extrusion die 310 directly into the lamination device 324 to form the laminated material sheet 600 by laminating with the fabric sheet 500 by the adhesive material in the lamination device 324. The following will mainly explain the differences between them.

Referring to FIG. 18, the third feeding device 320 supplies the fabric sheet 500 to the coating unit 362 of the lamination device 324, an adhesive material (e.g., solvent-based PU adhesive or water-based PU adhesive) is applied onto the fabric sheet 500 by the coating unit 362, and the fabric sheet 500 coated with the adhesive material is dried to form the coated fabric sheet 500A. Next, the coated fabric sheet 500A is fed between the oppositely disposed lamination rollers 370 of the lamination unit 364 of the lamination device 324, while the formed material sheet 400 discharged from the die outlet 334 of the sheet extrusion die 310 is also directly fed between the oppositely disposed lamination rollers 370 of the lamination unit 364, such that the coated fabric sheet 500A and the barrier layer of the formed material sheet 400 are bonded to each other, for example under pressure, to form the laminated material sheet 600. Since the formed material sheet 400 delivered from the die outlet 334 of the sheet extrusion die 310 is usually not completely solidified due to the high temperature, the formed material sheet 400 is directly fed into the lamination unit 364 for lamination, which may contribute to the tight bonding of the formed material sheet 400 and the adhesive material, and thus to the bonding strength between the formed material sheet 400 and the fabric sheet 500. The laminated material sheet 600 delivered from the lamination unit 364 of the lamination device 324 may subsequently be flattened and/or embossed, cooled, trimmed, and rolled by the pressing device 312, the cooling device 314, the trimming device 316, and the winding device 318, respectively.

It is to be appreciated that, although in the example embodiment shown in FIG. 18, the laminating and flattening and/or embossing are performed by the lamination device 324 and the pressing device 312, respectively, in further example embodiments, the lamination unit 364 of the lamination device 324 may also integrate the flattening and/or embossing functions such that the laminating and flattening and/or embossing may be accomplished simultaneously in one single device (e.g. the same roller set).

It is to be understood that FIGS. 13A to 18 are only schematic diagrams of example embodiments of a sheet manufacturing apparatuses and are only illustrative and not limiting. It is to be understood that the specific configurations of the devices of the sheet manufacturing apparatuses and the arrangement order of the devices can be adjusted according to actual needs, and some devices may be added or eliminated. As an example, the number and arrangement of rollers included in the respective devices of the sheet manufacturing apparatuses shown in the drawings are only illustrative, and the respective devices of the sheet manufacturing apparatuses may include other suitable numbers of rollers, or the rollers may be arranged in other ways. As another example, in one or more example embodiments, the pressing device 312 and the cooling 314 device may be integrated into one device to press and completely cool the formed material sheet 400. Still for another example, the sheet manufacturing apparatuses may also include additional cleaning devices for cleaning and dedusting the fabricated sheet.

Corresponding to the example embodiments of the sheet manufacturing apparatuses, example embodiments also provide a sheet manufacturing method.

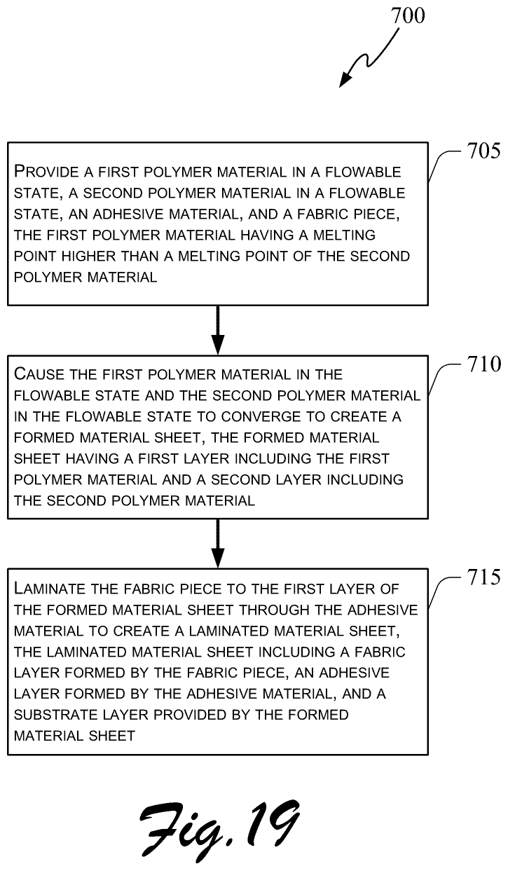

FIG. 19 shows a schematic flow chart of an example non-limiting embodiment of a sheet manufacturing method 700. All explanations above apply accordingly, unless they contradict newly mentioned features of this example embodiment. The sheet manufacturing method 700 in FIG. 19 includes: providing a first polymer material in a flowable state, a second polymer material in a flowable state, an adhesive material, and a fabric sheet 500, the first polymer material having a melting point higher than a melting point of the second polymer material; causing the first polymer material in the flowable state and the second polymer material in the flowable state to converge to create a formed material sheet, the formed material sheet having a barrier layer 402 including the first polymer material and a welding layer 404 including the second polymer material; and laminating the fabric sheet 500 to the barrier layer 402 of the formed material sheet by an adhesive material to create a laminated material sheet, the laminated material sheet including a fabric layer formed by the fabric sheet 500, an adhesive layer formed by the adhesive material, and a substrate layer provided by the formed material sheet.

According to one or more example embodiments, the formed material sheet obtained by the sheet manufacturing method includes an intermediate layer between the barrier layer 402 and the welding layer 404, and the intermediate layer includes a mixture of the first polymer material and the second polymer material. According to one or more example embodiments, both the first polymer material and the second polymer material used in the sheet manufacturing method are made of thermoplastic polyurethane.

According to one or more example embodiments of a sheet manufacturing method based on, for example, the sheet manufacturing apparatuses shown in FIGS. 13A to 17, the sheet manufacturing method further includes applying the adhesive material onto the fabric sheet 500 or the barrier layer 402 of the cooled material sheet 400B prior to laminating the fabric sheet 500 to the cooled material sheet 400B. According to one or more example embodiments of a sheet manufacturing method based on, for example, the sheet manufacturing apparatuses shown in FIGS. 13A to 17, the sheet manufacturing method further includes pressing the formed material sheet 400, wherein the pressing may include flattening and/or embossing. According to one or more example embodiments of a sheet manufacturing method based on, for example, the sheet manufacturing apparatuses shown in FIGS. 13A to 17, the sheet manufacturing method further includes cooling the pressed material sheet 400A.

According to one or more example embodiments of a sheet manufacturing method based on, for example, the sheet manufacturing apparatus shown in FIGS. 13A to 15, the sheet manufacturing method includes trimming the cooled material sheet 400B, and the fabric sheet 500 is laminated to the trimmed material sheet 400C by the adhesive material to form the laminated material sheet 600. Optionally, the sheet manufacturing method further includes winding the trimmed material sheet 400C into a trimmed material sheet roll R1, and unwinding the trimmed material sheet roll R1 to provide the trimmed material sheet 400C for lamination with the fabric sheet 500. According to one or more example embodiments of a sheet manufacturing method based on, for example, the sheet manufacturing apparatus shown in FIGS. 16 and 17, the sheet manufacturing method includes trimming the laminated material sheet 600 after laminating the fabric sheet 500 to the cooled material sheet 400B by the adhesive material to form the laminated material sheet 600.

According to one or more example embodiments of a sheet manufacturing method based on, for example, the sheet manufacturing apparatus shown in FIG. 18, the sheet manufacturing method includes applying the adhesive material onto the fabric sheet 500 and laminating the fabric sheet 500, onto which the adhesive material has been applied, to the formed material sheet 400 to create the laminated material sheet 600. According to one or more example embodiments of a sheet manufacturing method based on, for example, the sheet manufacturing apparatus shown in FIG. 18, the sheet manufacturing method further includes pressing the laminated material sheet 600 while or after laminating the fabric sheet 500 onto which the adhesive material has been applied to the formed material sheet 400 to form the laminated material sheet, the pressing including flattening and/or embossing. According to one or more example embodiments of a sheet manufacturing method based on, for example, the sheet manufacturing apparatus shown in FIG. 18, the sheet manufacturing method further includes cooling the pressed material sheet 400A. According to one or more example embodiments of a sheet manufacturing method based on, for example, the sheet manufacturing apparatus shown in FIG. 18, the sheet manufacturing method further includes trimming the cooled material sheet 400B.

It should be understood that the example embodiments described herein are to be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A sheet comprising:
a substrate layer including:
a barrier layer comprising a first polymer material; and
a welding layer comprising a second polymer material;
wherein the substrate layer is formed by converging the first polymer material in a flowable state and the second polymer material in a flowable state; and
a melting point of the first polymer material is higher than a melting point of the second polymer material.

2. The sheet according to claim 1, wherein the substrate layer further comprises an intermediate layer disposed between the barrier layer and the welding layer, wherein the intermediate layer comprises a mixture of the first polymer material and the second polymer material.

3. The sheet according to claim 1, wherein each of the first polymer material and the second polymer material comprises at least one of a thermoplastic polyurethane elastomer, polyethylene, polypropylene, polyvinyl chloride, polyvinylidene chloride, and polyurethane.

4. The sheet according to claim 1, wherein the melting point of the first polymer material is at least 15° C. higher than the melting point of the second polymer material.

5. The sheet according to claim 1, wherein the barrier layer has a Shore A hardness (HA) in a range of about 80 HA to 98 HA, and the welding layer has a Shore A hardness in a range of about 75 HA to 95 HA.

6. The sheet according to claim 1, wherein a ratio of a thickness of the barrier layer to a thickness of the welding layer is in a range of about 1:1 to 1:4.

7. The sheet according to claim 1, wherein the substrate layer has a thickness in a range of about 0.01 millimeters (mm) to 0.40 mm.

8. The sheet according to claim 1, further comprising a fabric layer and an adhesive layer disposed between the fabric layer and the barrier layer, the adhesive layer joining the fabric layer to the barrier layer to form a laminated sheet.

9. An inflatable product comprising:
a first sheet;
a second sheet connected to the first sheet; and
an inflatable chamber defined by the first sheet and the second sheet;
wherein the first sheet comprises:
a substrate layer including a barrier layer comprising a first polymer material and a welding layer comprising a second polymer material, wherein a melting point of the first polymer material is higher than a melting point of the second polymer material;
an adhesive layer disposed on the barrier layer of the substrate layer; and
a fabric layer joined to the adhesive layer to laminate the fabric layer to the substrate layer.

10. The inflatable product according to claim 9, further comprising:
a connecting sheet disposed in the inflatable chamber;
wherein the connecting sheet comprises:
a plurality of first welding regions in which the connecting sheet is welded to the first sheet, and
a plurality of second welding regions in which the connecting sheet is welded to the second sheet,
wherein the plurality of first welding regions are staggered with respect to the plurality of second welding regions.

11. The inflatable product according to claim 9, further comprising:
a thermal insulation sheet disposed in the inflatable chamber;
wherein the thermal insulation sheet comprises:
a polymer substrate, and
a metal coating layer coated on at least one side of the polymer substrate.

12. The inflatable product according to claim 11, wherein the polymer substrate of the thermal insulation sheet is formed from at least one of polyvinyl chloride, polypropylene, polyethylene terephthalate, and polyamide.

13. The inflatable product according to claim 9, further comprising:
a plurality of tensioning members disposed in the inflatable chamber;
wherein each of the plurality of tensioning members comprises a top edge welded to the welding layer of the first sheet and a bottom edge welded to the welding layer of the second sheet.

14. The inflatable product according to claim 13, wherein each of the plurality of tensioning members comprises a substrate layer comprising a first tensioning layer comprising a first polymer material and a second tensioning layer comprising a second polymer material, wherein a melting point of the first polymer material is higher than a melting point of the second polymer material.

15. The inflatable product according to claim 13, wherein each of the plurality of tensioning members comprises polyamide fiber or polyethylene terephthalate fiber.

16. The inflatable product according to claim 9, further comprising:
a foam core disposed in the inflatable chamber;
wherein a top surface of the foam core is laminated to the first sheet and a bottom surface of the foam core is laminated to the second sheet.

17. The inflatable product according to claim 16, wherein the foam core comprises one of a plurality of uniformly-distributed apertures and a plurality of uniformly-distributed grooves.

18. The inflatable product according to claim 16 further comprising an inflation valve, wherein:
the foam core disposed within the inflatable product may be compacted to assume a smaller volume thereof by application of an external compressive force and expands upon removal of the external compressive force;
the inflatable product may be configured into a decreased volume storage configuration by:
translating the inflation valve to an open position thereof;
applying the external compression force to an external area of the inflatable product, thereby compressing the foam core and expelling gasses from within the inflatable product; and
translating the inflation valve to a closed position thereof, thereby preventing external gasses from re-entering the inflatable product and retaining the foam core in a compressed state thereof by external air pressure acting on external surfaces of the inflatable product; and
the inflatable product may be configured into an inflated use configuration by:
translating the inflation valve to an open position thereof, whereby an expansive force of the compressed foam core urges external gasses to enter the inflatable product; and
translating the inflation valve to a closed position thereof after the inflatable product has expanded to a predetermined volume to maintain the inflatable product in the inflated use configuration.

19. The inflatable product according to claim 9, further comprising:
a lateral sheet;
wherein a top edge of the lateral sheet is connected to a periphery of the first sheet, and a bottom edge of the lateral sheet is connected to a periphery of the second sheet, such that the first sheet, the second sheet, and the lateral sheet jointly define the inflatable chamber.

20. The inflatable product according to claim 9, wherein the first sheet is directly welded to the second sheet at a plurality of distributed weld lines and weld points so that the inflatable pad maintains a predetermined shape in an inflated state.
